(19) United States
(12) Patent Application Publication
(10) Pub. No.: US 2024/0231754 A1
(43) Pub. Date: Jul. 11, 2024

(54) METHOD AND SYSTEM THAT AGGREGATES LOG/EVENT MESSAGES BASED ON SEMANTIC SIMILARITY

(71) Applicant: VMware LLC, Palo Alto, CA (US)

(72) Inventors: Sameer Chandra Tatiraju, Bangalore (IN); Agnello Noronha, Bangalore (IN); Manish Balchand Jain, Bangalore (IN)

(21) Appl. No.: 18/119,855

(22) Filed: Mar. 10, 2023

(30) Foreign Application Priority Data
Jan. 5, 2023 (IN) 202341001127

(51) Int. Cl. G06F 7/02; G06F 9/54; G06F 17/16

(52) U.S. Cl. CPC G06F 7/02; G06F 9/542; G06F 9/546; G06F 17/16

(57) ABSTRACT

The current document is directed to methods and subsystems within distributed computer systems that automatically aggregate semantically similar log/event messages. Aggregation of semantically similar log/event messages can significantly decrease the volume of unique log/event messages that are processed and stored by log/event-message subsystems within distributed computer systems and, by doing so, decrease significant computational, networking, data-storage, and administration and management overheads associated with log/event-message subsystems. In various described implementations, sentence embeddings for the semantic content of log/event messages are used to continuously identify, within sliding time windows, semantically similar log/event messages and to aggregate the log/event messages in order to reduce the quantity of log/event messages that need to be processed and stored by log/event-message subsystems.

### RELATED APPLICATIONS

Benefit is claimed under 35 U.S.C. 119(a)-(d) to Foreign Application Serial No. 202341001127 filed in India entitled “METHOD AND SYSTEM THAT AGGREGATES LOG/EVENT MESSAGES BASED ON SEMANTIC SIMILARITY”, on Jan. 5, 2023, by VMware, Inc., which is herein incorporated in its entirety by reference for all purposes.

### TECHNICAL FIELD

The current document is directed to distributed computer systems and, in particular, to methods and systems within distributed computer systems that automatically aggregate semantically similar log/event messages.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computer systems with hundreds of thousands, millions, or more components that provide enormous computational bandwidths and data-storage capacities. These large, distributed computer systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computer systems appears likely to continue well into the future.

As the complexity of distributed computer systems has increased, the management and administration of distributed computer systems has, in turn, become increasingly complex, involving greater computational overheads and significant inefficiencies and deficiencies. As one example, distributed computer systems employ sophisticated log/event-message systems that collect log/event messages from a myriad of different log/event-message sources, process and store the collected log/event messages, automatically generate alarms and notifications that, in turn, elicit both automated and manual actions to address various different types of problems and operational states identified from the processed and collected log/event messages, and display log/event messages to system administrators and managers, via query-based retrieval-and-display subsystems, to facilitate administration and management of the distributed computer systems. A particular distributed computer system may include multiple different log/event-message subsystems. Log/event-message systems generate enormous volumes of log/event messages on a daily basis, in certain distributed computer systems up to two or more terabytes of log/event messages per day. The generation, processing, and storage of log/event messages represents a significant computational, networking, and data-storage overhead. Managing and using the collected log/event messages also represents a significant computational, networking, and data-storage overhead as well as a significant overhead in personnel time and effort. For this reason, developers, manufacturers, vendors, and users of distributed computer systems and log/event-message systems continue to seek improvements that provide increased efficiencies in the many different overheads associated with log/event-message systems.

### SUMMARY

The current document is directed to methods and systems within distributed computer systems that automatically aggregate semantically similar log/event messages. Aggregation of semantically similar log/event messages can significantly decrease the volume of unique log/event messages that are processed and stored by log/event-message systems within distributed computer systems and, by doing so, decrease significant computational, networking, data-storage, and administration and management overheads associated with log/event-message systems. In various described implementations, sentence embeddings for the semantic content of log/event messages are used to continuously identify, within sliding time windows, semantically similar log/event messages and to aggregate the semantically similar log/event messages in order to reduce the quantity of log/event messages that need to be processed and stored by log/event-message systems and to facilitate efficient log/event-message analysis.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a small, 11-entry portion of a log file from a distributed computer system.

FIG. 12 illustrates generation of log/event messages within a server.

FIGS. 13A-D illustrate two different types of log/event-message collection and forwarding within distributed computer systems.

FIGS. 14A-B provide block diagrams of generalized log/event-message systems incorporated within one or more distributed computer systems.

FIG. 15 illustrates log/event-message preprocessing.

FIG. 16 illustrates processing of log/event messages by a message-collector component or a message-ingestion-and-processing component.

FIG. 17 illustrates various common types of initial log/event-message processing carried out by message-collector systems and/or message-ingestion-and-processing systems.

FIG. 18 illustrates operation of a circular queue.

FIG. 19 illustrates an implementation of a circular queue.

FIG. 20 illustrates fundamental components of a feed-forward neural network.

FIGS. 21A-J illustrate operation of a very small, example neural network.

FIGS. 22A-C show details of the computation of weight adjustments made by neural-network nodes during backpropagation of error vectors into neural networks.

FIGS. 23A-B illustrate neural-network training.

FIGS. 24A-F illustrate a matrix-operation-based batch method for neural-network training.

FIG. 25 illustrates word embeddings.

FIG. 26 illustrates one approach to training a neural-network used for generating embedding vectors for the words of a vocabulary.

FIG. 27 shows that the same neural-network training approach discussed above with reference to FIG. 26 can be used to train a neural network to receive a one-hot encoding of a bi-gram, or pair of adjacent words in a training document, and output a probability distribution for the probabilities of vocabulary words occurring adjacent to the b-gram in the training documents.

FIG. 28 illustrates sentence embeddings.

FIG. 29 illustrates one approach to generating sentence-embedding vectors.

FIG. 30 illustrates one example of training data used to train a DAN for use in generating sentence-embedding vectors.

FIG. 31 illustrates the concept of semantic content in log/event messages.

FIG. 32 illustrates an example of semantically similar content in redundant log/event messages.

FIG. 33 illustrates several possible approaches to aggregating semantically similar log/event messages that occur in close proximity in time.

FIG. 34 illustrates determination of the semantic similarity of the semantic content of two log/event messages.

FIG. 35 illustrates one implementation of a sliding-window semantic-similarity-detection method incorporated in implementations of the currently disclosed methods and systems for aggregating semantically similar log/event messages.

FIGS. 36-43 provide a simple C++ implementation of the sliding-window similarity-based aggregating circular queue discussed with reference to FIG. 35.

FIG. 44 illustrates various points in a log/event-message system at which similar-message-aggregating queues can be used for aggregating semantically similar log/event messages.

### DETAILED DESCRIPTION

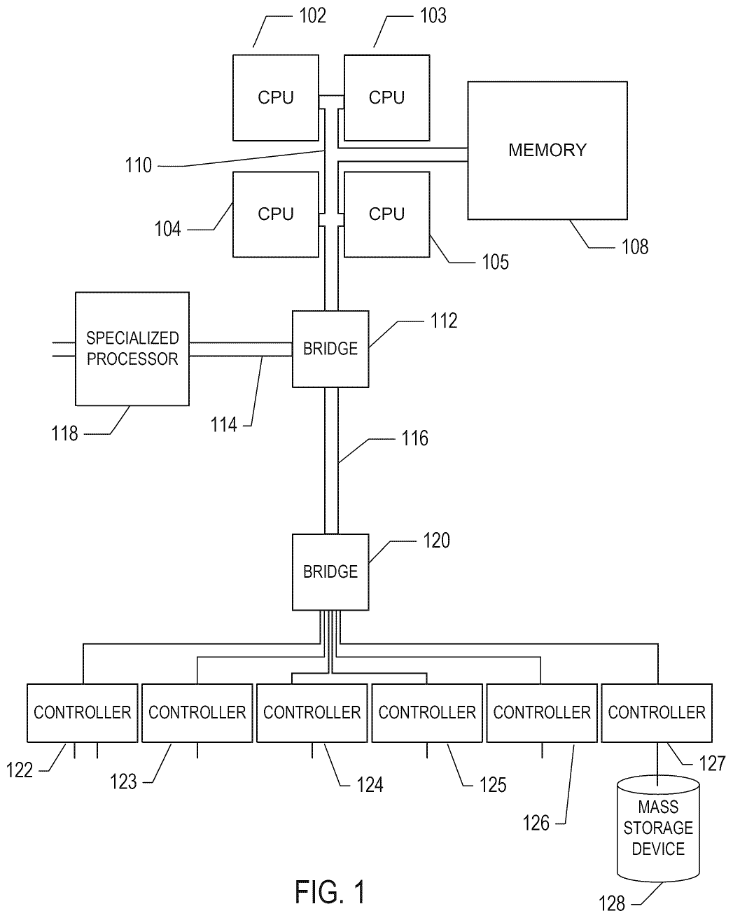

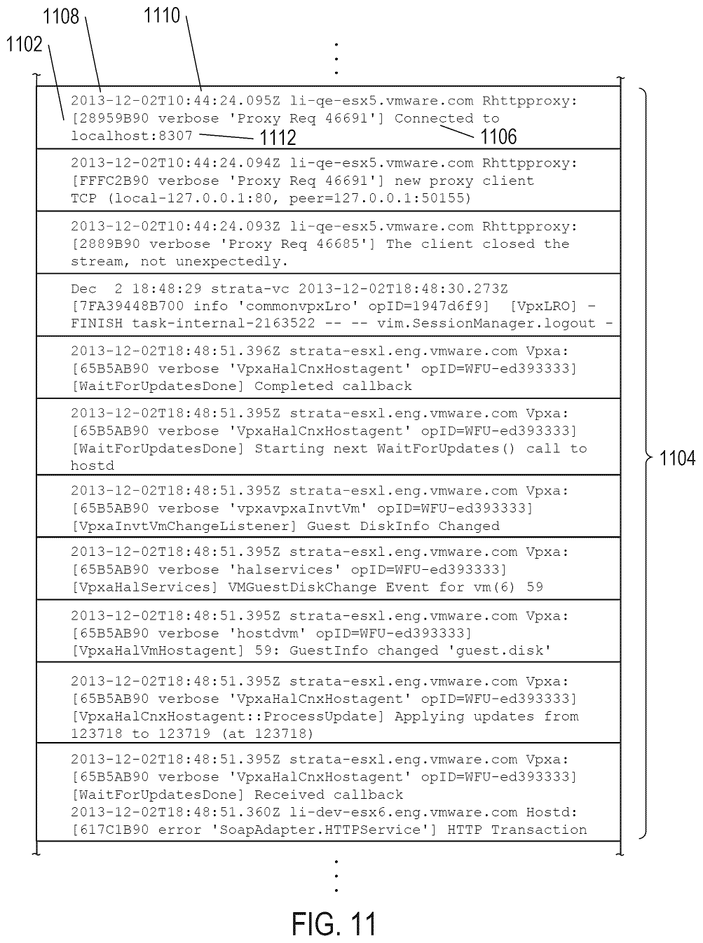

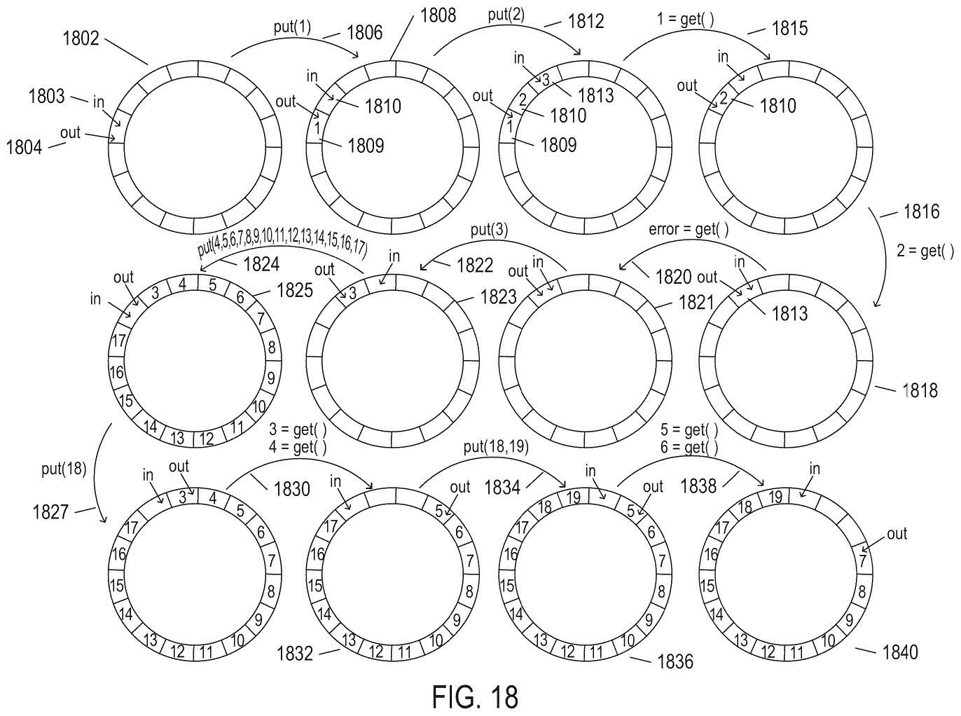

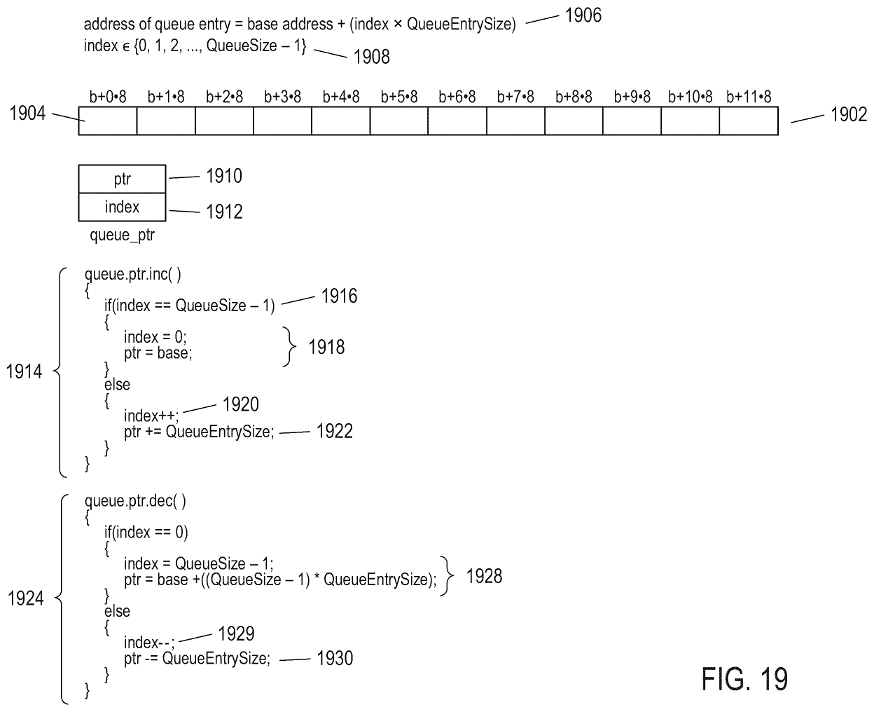

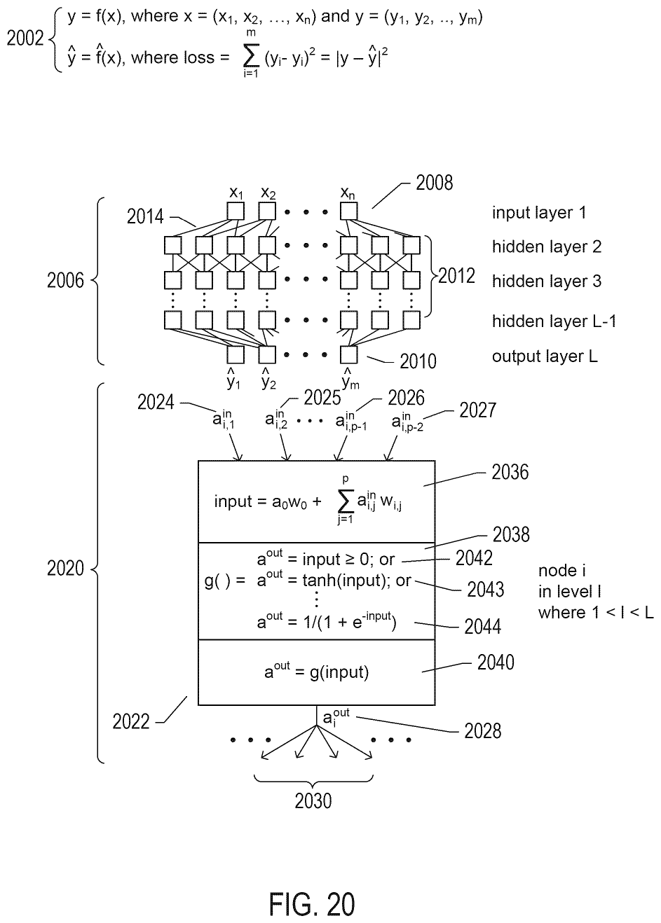

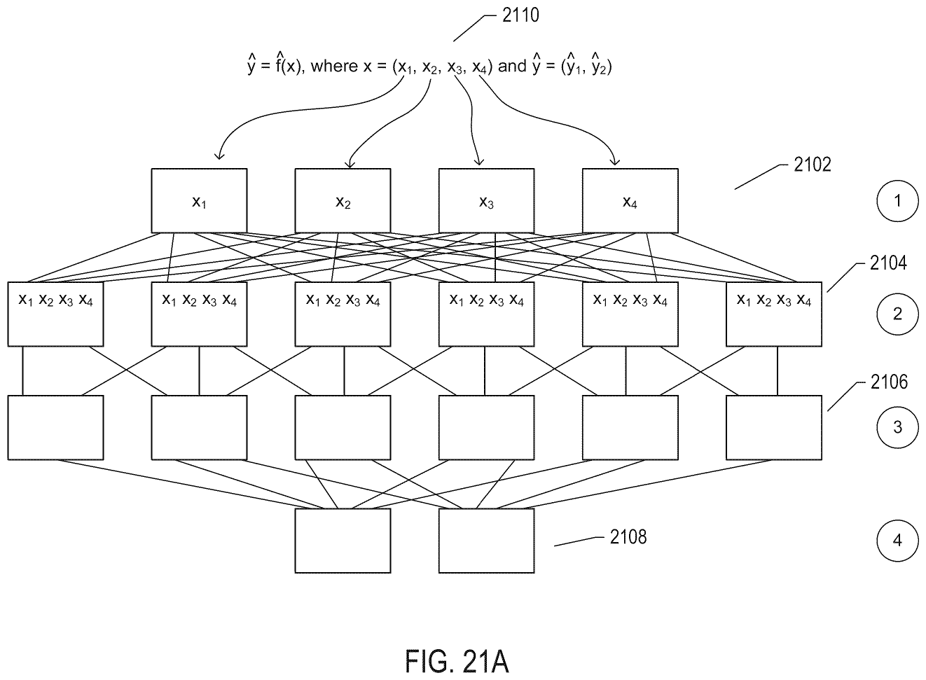

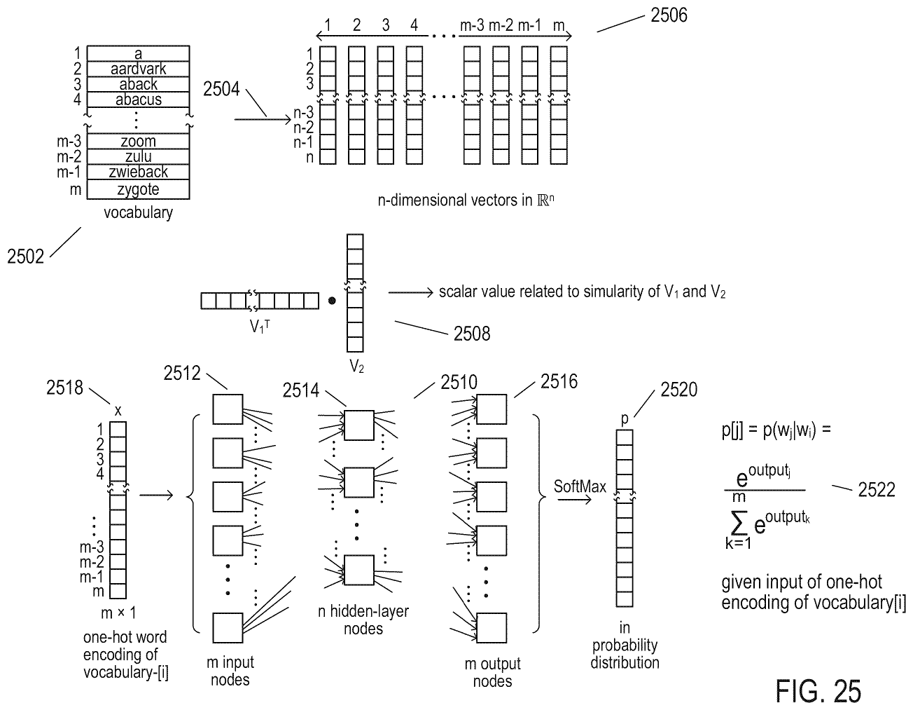

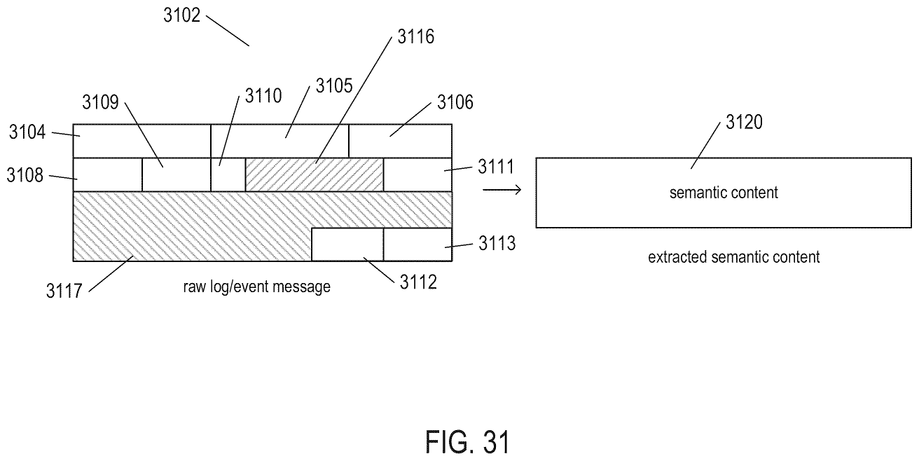

The current document is directed to methods and systems within distributed computer systems that automatically aggregate semantically similar log/event messages. In a first subsection, below, a detailed description of computer hardware, complex computational systems, and virtualization is provided with reference to FIGS. 1-10. In a second subsection, an overview of log/event-message systems is provided with reference to FIGS. 11-17. In a third subsection, circular queues are discussed with reference to FIGS. 18-19. In a fourth subsection, neural networks are discussed with reference to FIGS. 20-24B. In a fifth subsection, word and sentence embeddings are discussed with reference to FIGS. 25-30. Finally, in a sixth subsection, the currently disclosed methods and systems are discussed with reference to FIGS. 31-43.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

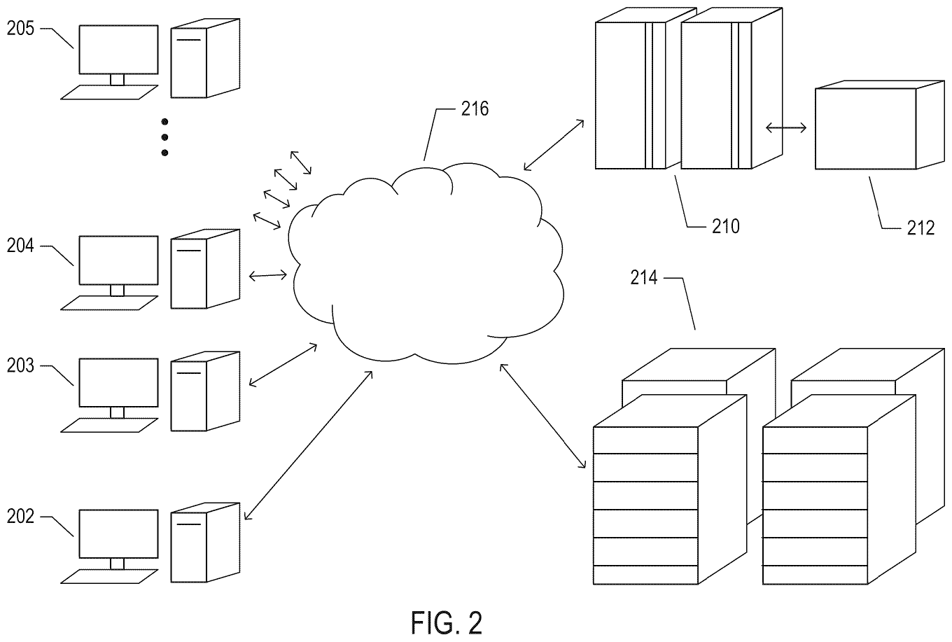

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

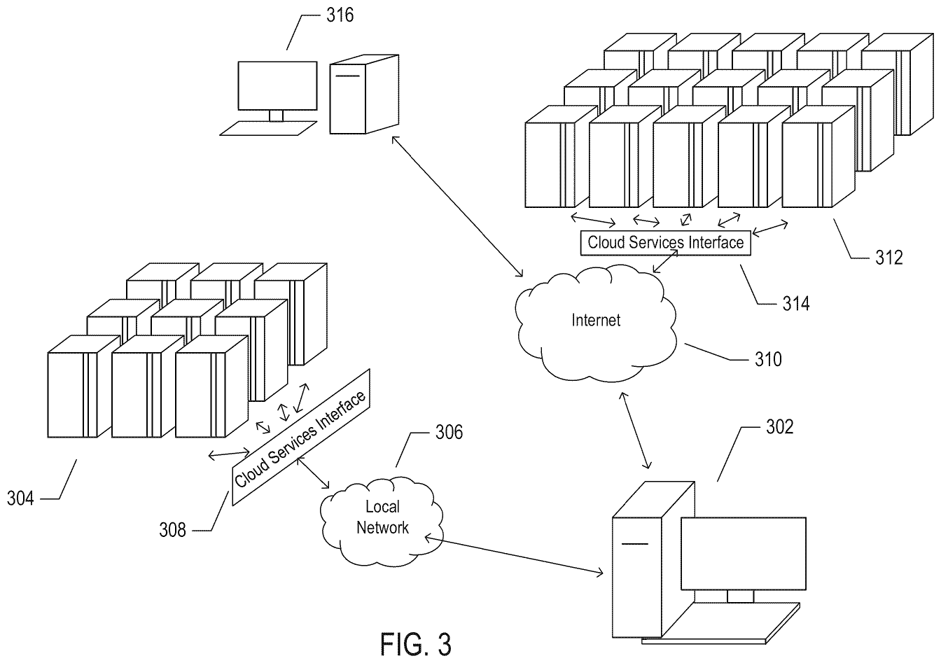

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

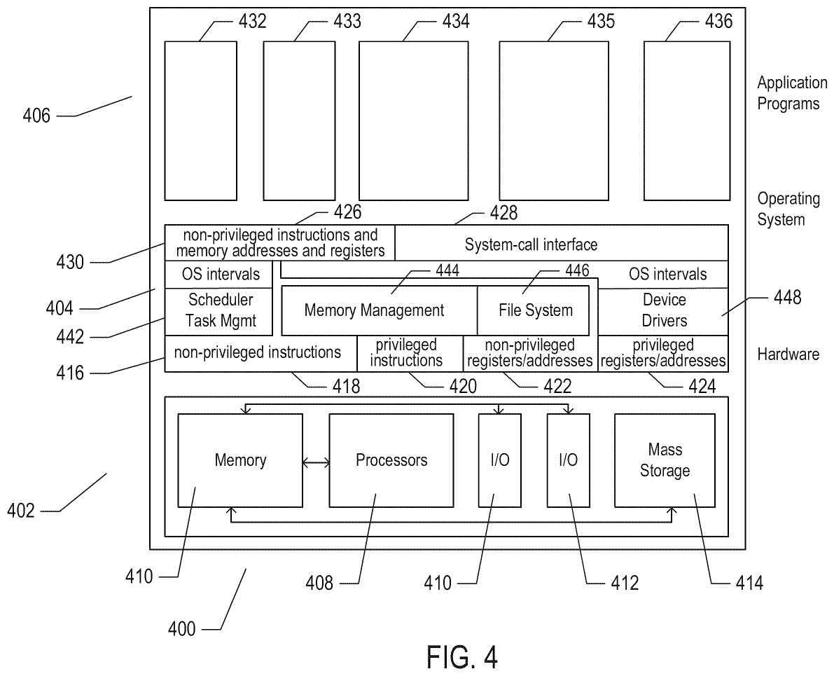

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

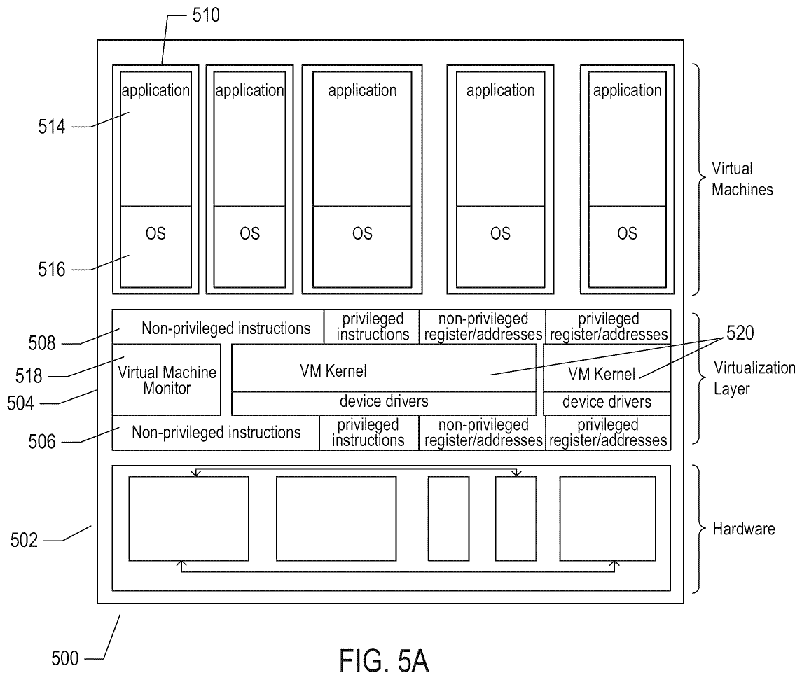

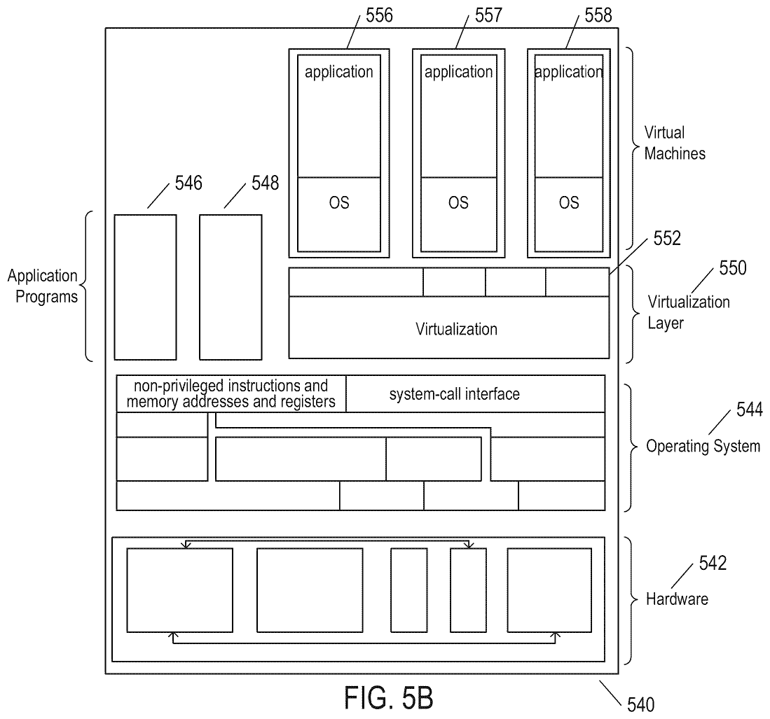

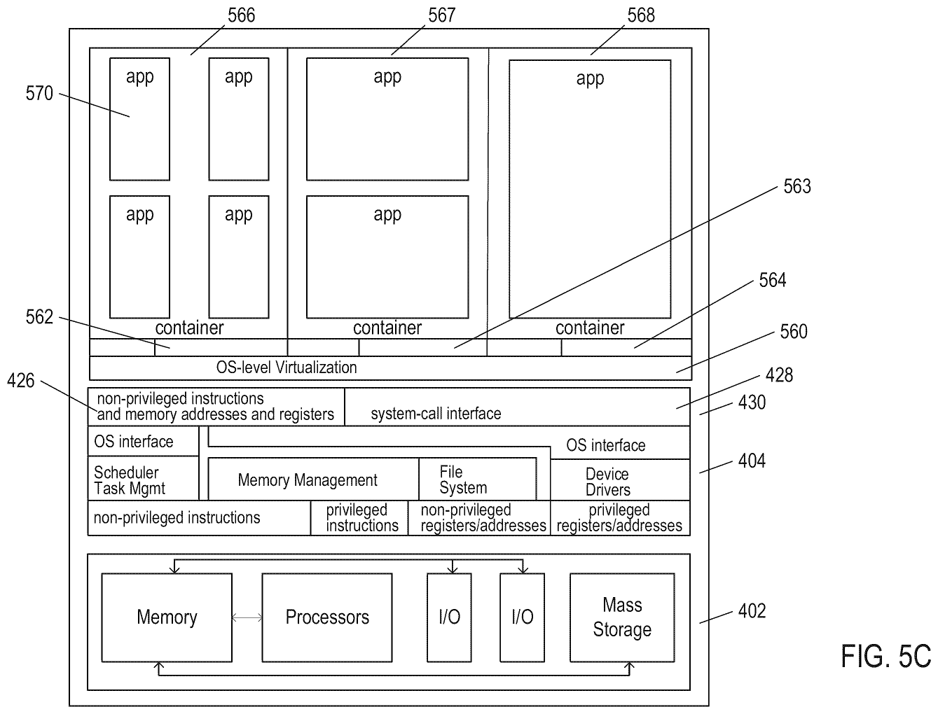

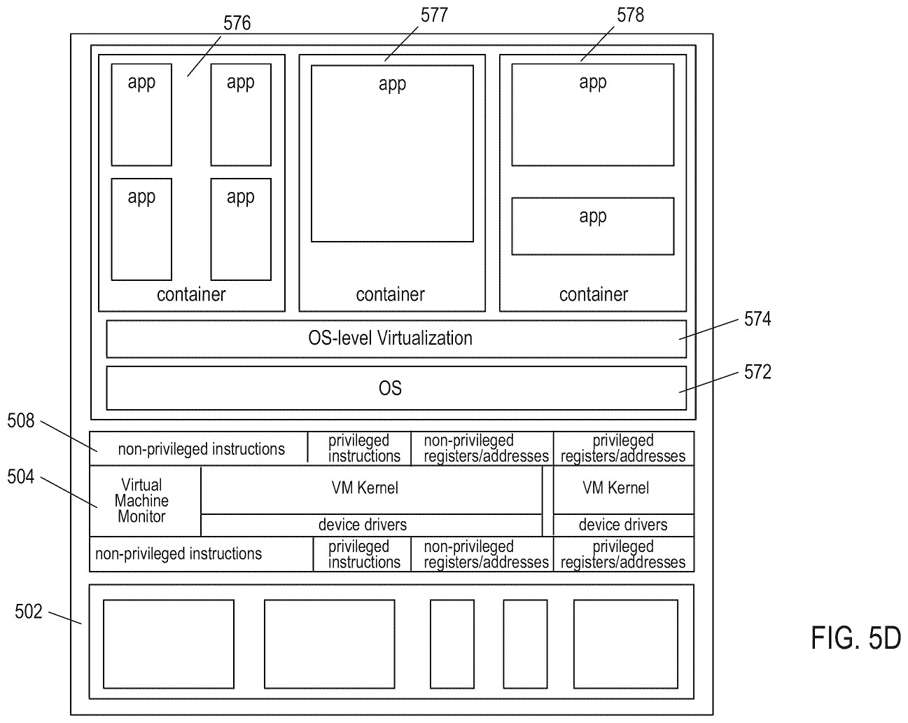

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computer systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

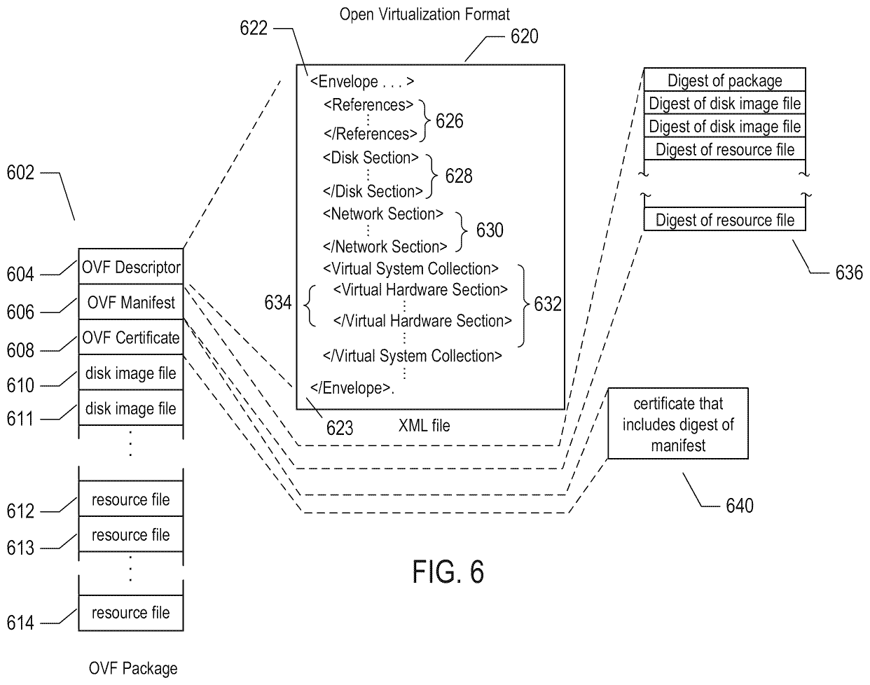

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

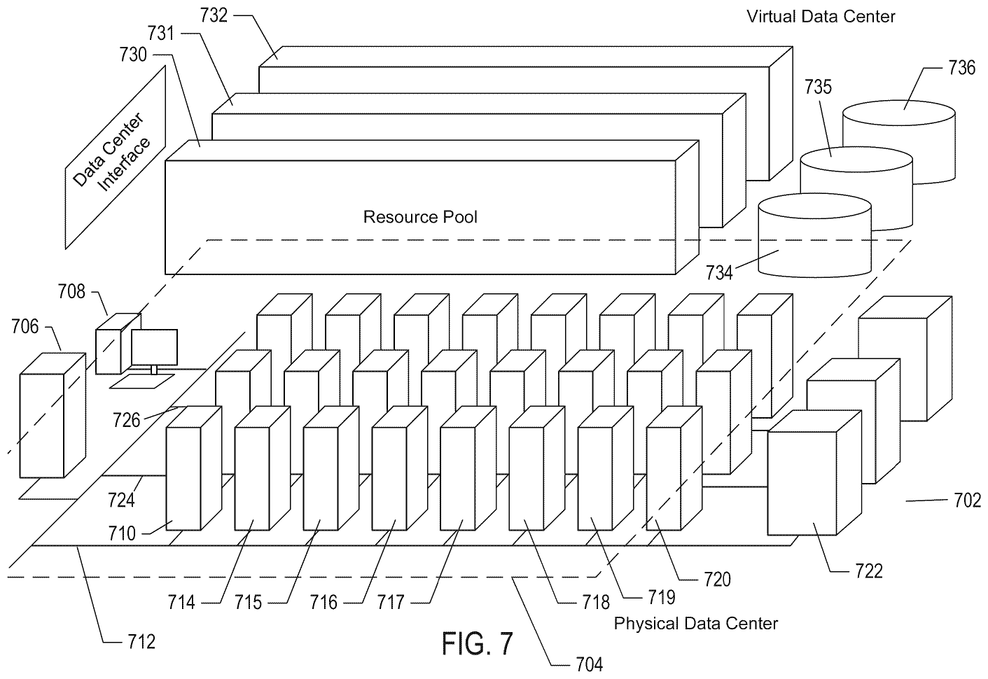

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

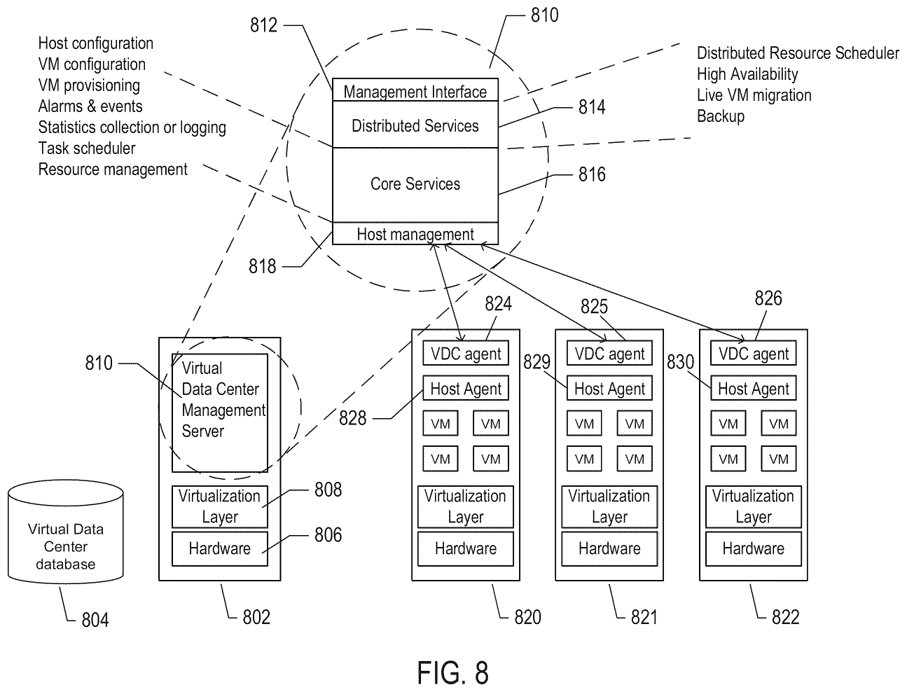

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

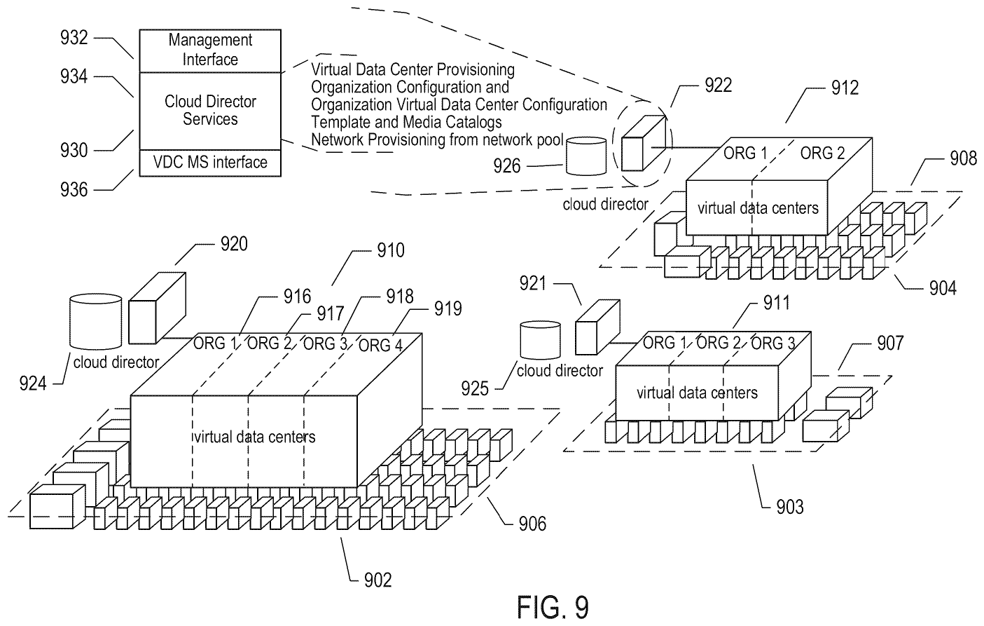

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

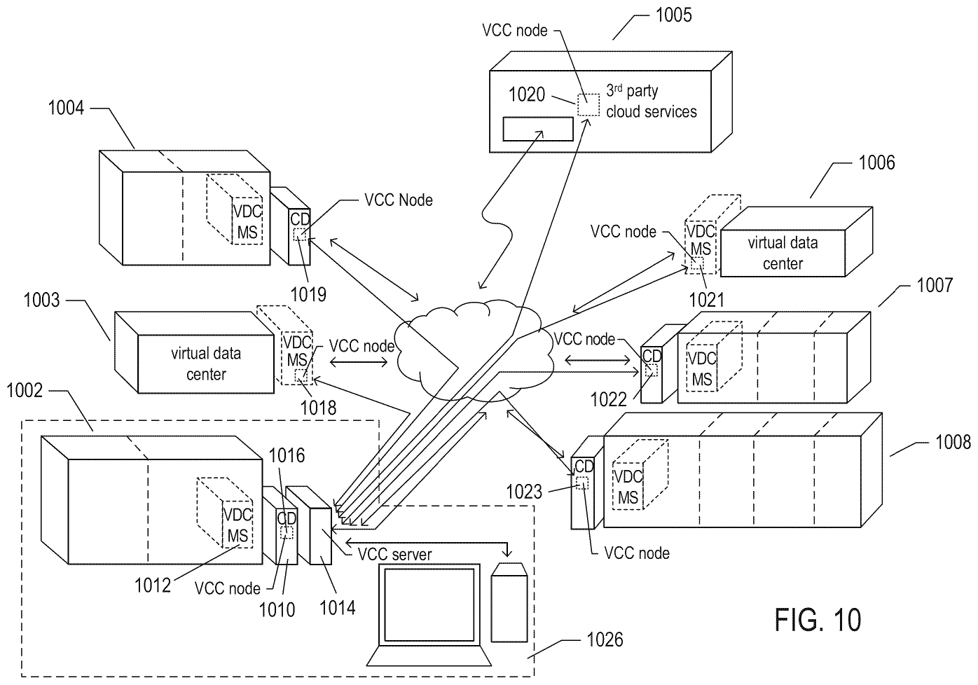

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### An Overview of Log/Event-Message Systems

Modern distributed computer systems feature a variety of different types of automated and semi-automated administration and management subsystems that detect anomalous operating behaviors of various components of the distributed computer systems, collect errors reported by distributed-computer-system components, and use the detected anomalies and collected errors to monitor and diagnose the operational states of the distributed computer systems in order to automatically undertake corrective and ameliorative actions and to alert human system administrators of potential, incipient, and already occurring problems. Log/event-message reporting, collecting, storing, and querying systems and subsystems are fundamental components of administration and management subsystems. The phrase “log/event message” refers to various types of generally short log messages and event messages issued by message-generation-and-reporting functionality incorporated within many hardware components, including network routers and bridges, network-attached storage devices, network-interface controllers, virtualization layers, operating systems, applications running within servers and other types of computer systems, and additional hardware devices incorporated within distributed computer systems. The log/event messages generally include both text and numeric values and represent various types of information, including notification of completed actions, errors, anomalous operating behaviors and conditions, and various types of computational events, warnings, and other such information. The log/event messages are transmitted to message collectors, generally running within servers of local data centers, which forward collected log/event messages to message-ingestion-and-processing components that collect and store log/event messages in message databases. Log/event-message query-processing subsystems provide, to administrators and managers of distributed computer systems, query-based access to log/event messages in message databases. The message-ingestion-and-processing components may additionally provide a variety of different types of services, including automated generation of alerts, filtering, and other message-processing services.

Large modern distributed computer systems may generate enormous volumes of log/event messages, from tens of gigabytes (“GB”) to terabytes (“TB”) of log/event messages per day. Generation, transmission, and storage of such large volumes of data represent significant networking-bandwidth, processor-bandwidth, and data-storage overheads for distributed computer systems, significantly decreasing the available networking bandwidth, processor bandwidth, and data-storage capacity for supporting client applications and services. In addition, the enormous volumes of log/event messages generated, transmitted, and stored on a daily basis result in significant transmission and processing latencies, as a result of which greater than desired latencies in alert generation and processing of inquiries directed to stored log/event messages are often experienced by automated and semi-automated administration tools and services as well as by human administrators and managers.

FIG. 11 shows a small, 11-entry portion of a log file from a distributed computer system. A log file may store log/event messages for archival purposes, in preparation for transmission and forwarding to processing systems, or for batch entry into a log/event-message database. In FIG. 11, each rectangular cell, such as rectangular cell 1102, of the portion of the log file 1104 represents a single stored log/event message. In general, log/event messages are relatively cryptic, including only one or two natural-language sentences or phrases as well as various types of file names, path names, network addresses, component identifiers, and other alphanumeric parameters. For example, log entry 1102 includes a short natural-language phrase 1106, date 1108 and time 1110 parameters, as well as a numeric parameter 1112 which appears to identify a particular host computer.

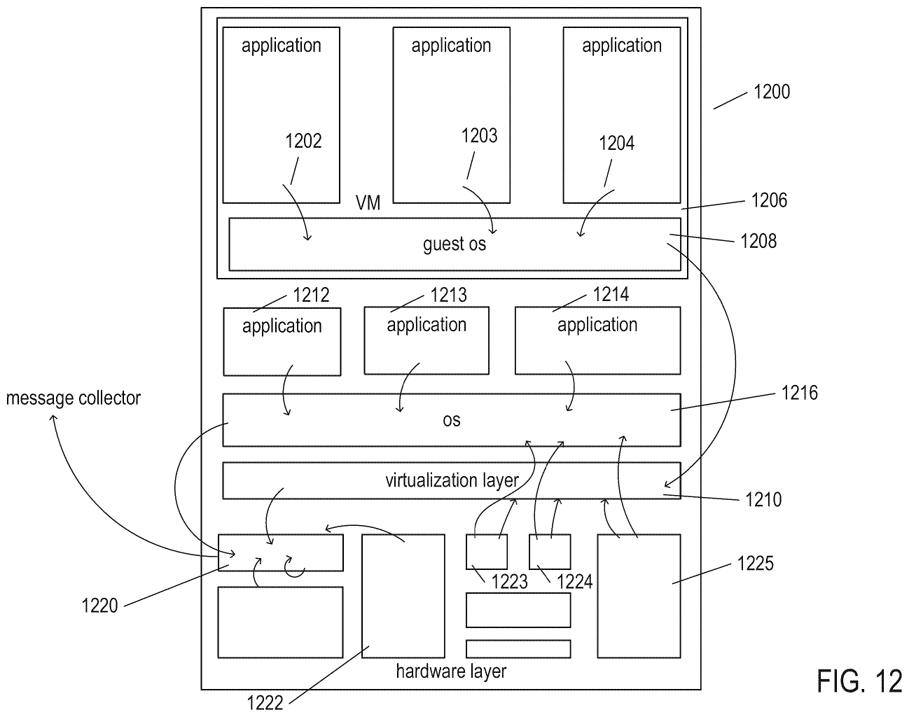

FIG. 12 illustrates generation of log/event messages within a server. A block diagram of a server 1200 is shown in FIG. 12. Log/event messages can be generated within application programs, as indicated by arrows 1202-1204. In this example, the log/event messages generated by applications running within an execution environment provided by a virtual machine 1206 are reported to a guest operating system 1208 running within the virtual machine. The application-generated log/event messages and log/event messages generated by the guest operating system are, in this example, reported to a virtualization layer 1210. Log/event messages may also be generated by applications 1212-1214 running in an execution environment provided by an operating system 1216 executing independently of a virtualization layer. Both the operating system 1216 and the virtualization layer 1210 may generate additional log/event messages and transmit those log/event messages along with log/event messages received from applications and the guest operating system through a network interface controller 1222 to a message collector. In addition, various hardware components and devices within the server 1222-1225 may generate and send log/event messages either to the operating system 1216 and/or virtualization layer 1210, or directly to the network interface controller 122 for transmission to the message collector. Thus, many different types of log/event messages may be generated and sent to a message collector from many different components of many different component levels within a server computer or other distributed-computer-system components, such as network-attached storage devices, networking devices, and other distributed-computer-system components.

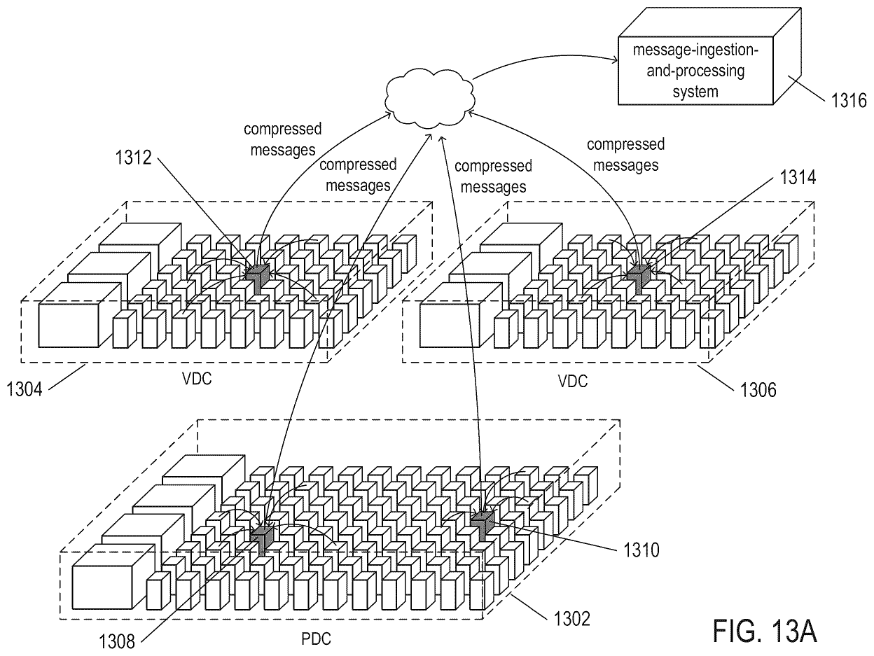

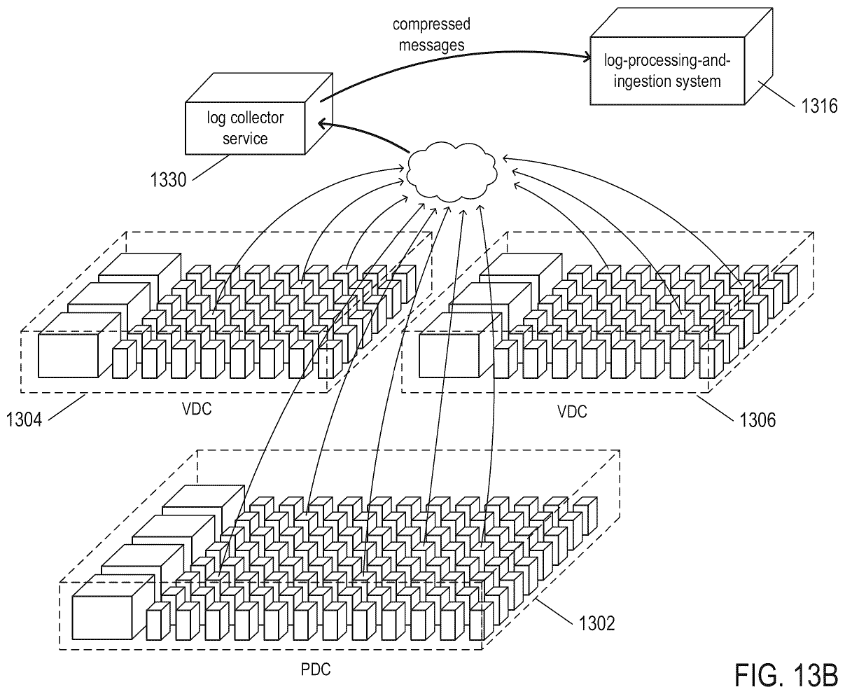

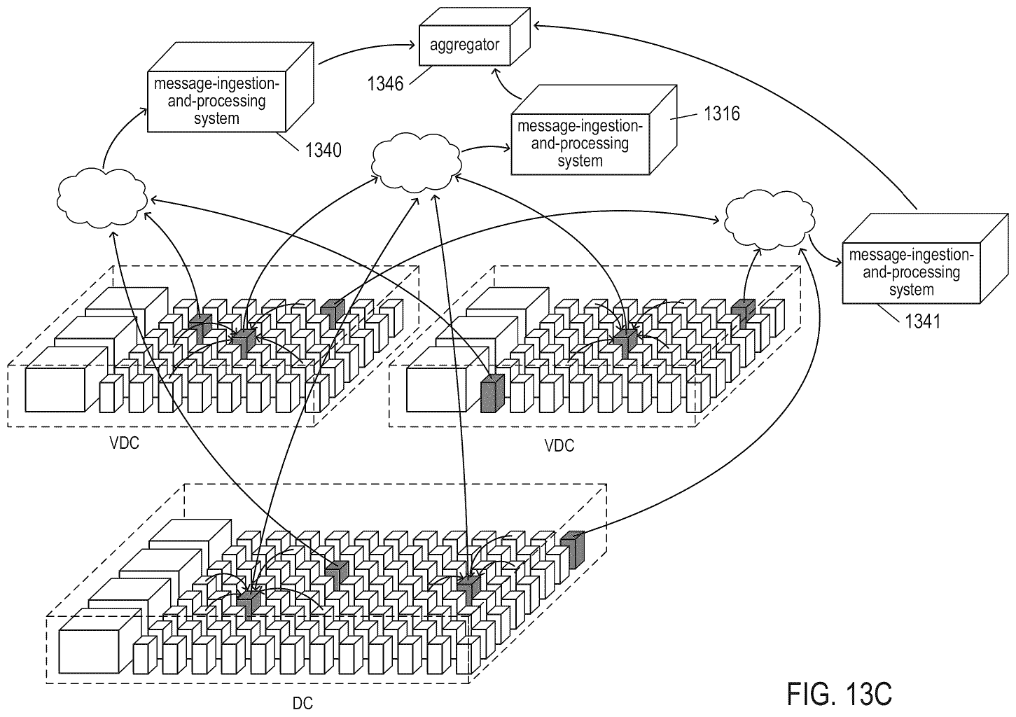

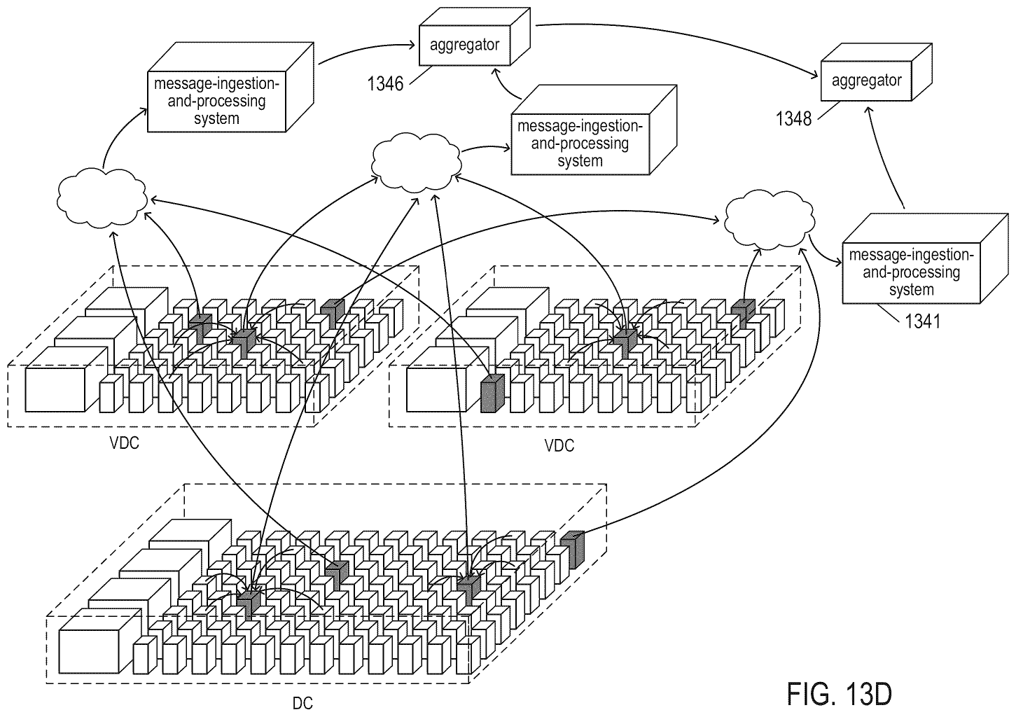

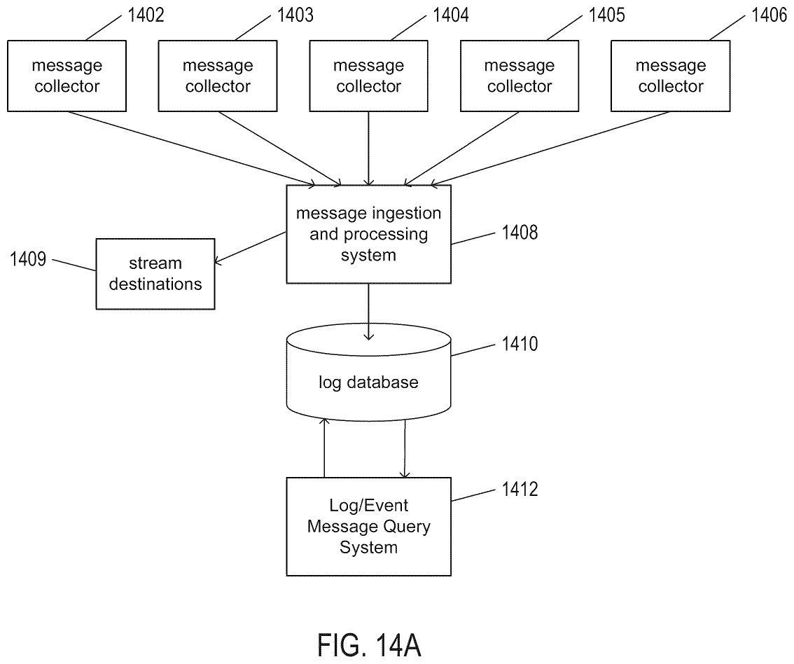

FIGS. 13A-D illustrate different types of log/event-message collection and forwarding within distributed computer systems. FIG. 13A shows a distributed computer system comprising a physical data center 1302 above which two different virtual data centers 1304 and 1306 are implemented. The physical data center includes two message collectors running within two physical servers 1308 and 1310. Each virtual data center includes a message collector running within a virtual server 1312 and 1314. The message collectors compress batches of the collected messages and forward the compressed messages to a message-processing-and-ingestion component 1316. In certain cases, each distributed computing facility owned and/or managed by a particular organization may include one or more message-processing-and-ingestion components dedicated to collection and storage of log/event messages for the organization. In other cases, the message-processing-and-ingestion components may provide log/event-message collection and storage for multiple distributed computing facilities owned and managed by multiple different organizations. In this example, log/event messages may be produced and reported both from the physical data center as well as from the higher-level virtual data centers implemented above the physical data center. In alternative schemes, message collectors within a distributed computer system may collect log/event messages generated both at the physical and virtual levels.

FIG. 13B shows the same distributed computer system 1302, 1304, and 1306 shown in FIG. 13A. However, in the log/event-message reporting scheme illustrated in FIG. 13B, log/event messages are collected by a remote message-collector service 1330 which then forwards the collected log/event messages to a message-processing-and-ingestion system 1316. As shown in FIG. 13C, a distributed computer system, such as that shown in FIG. 13A, may concurrently host multiple different message-ingestion-and-processing components 1316 and 1340-1341 of multiple different log/event-message subsystems. Each message-ingestion-and-processing component, along with message collectors employed by the message-ingestion-and-processing component, may represent a separate log/event-message subsystem. Each of the concurrently operating log/event-message subsystems may employ different log/event message formats and, for those events commonly detected by two or more of the log/event-message subsystems, may include different parameter values and textual contents. The distributed computer system may additionally employ a higher-level log/event-message aggregator 1346 that provides query-based access to log/event messages stored by each of the different log/event-message subsystems. As shown in FIG. 13D, a distributed computer system may employ multiple log/event-message aggregators 1346 and 1348, with the highest-level aggregator 1348 providing query-based access to log/event messages stored by message-indigestion-and-processing component 1341 and to log/event messages accessed via lower-level aggregator 1346. Thus, there may be multiple different concurrently operating log/event-message subsystems that collect, process, and store log/event messages, within a distributed computer system and the log/event messages collected, processed, and stored by these multiple different log/event-message subsystems may be separately accessed or may be accessed through one or more different aggregators that may represent additional hierarchical levels in the overall log/event-message collection, processing, and storage machinery within the distributed computer system, referred to as a “log/event-message system” to contrast such a multi-subsystem implementation with a single-log/event-message subsystem implementation. Thus, the phrase “log/event-message system” refers to all of one or more log/event-message subsystems incorporated in a distributed computer system.

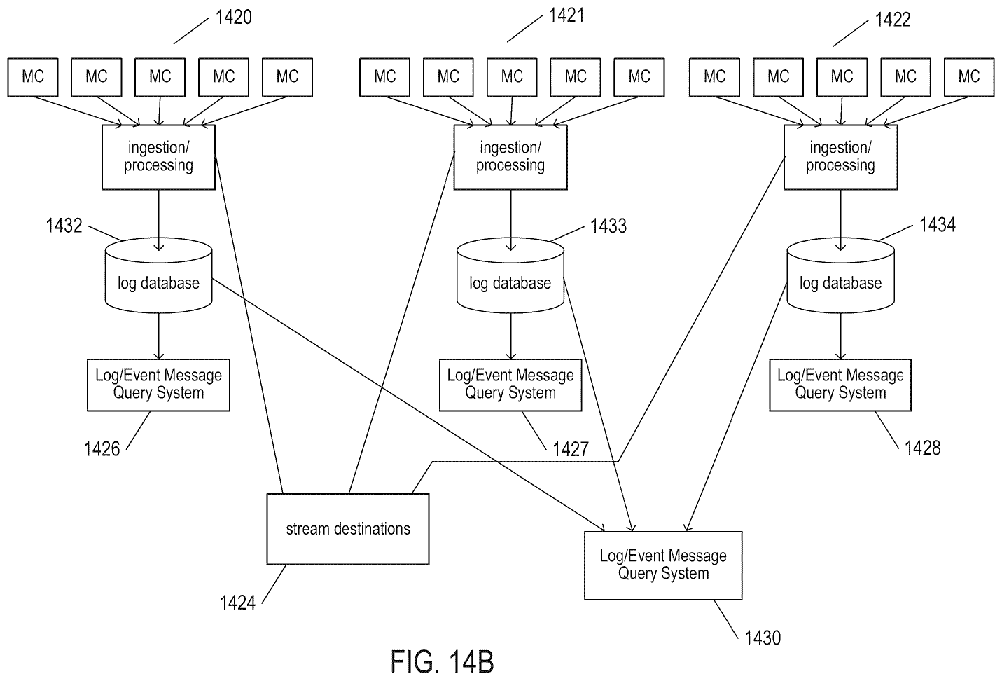

FIGS. 14A-B provide block diagrams of generalized log/event-message systems incorporated within one or more distributed computer systems. FIG. 14 provides a block diagram of a single log/event-message subsystem. Message collectors 1402-1406 receive log/event messages from log/event-message sources, including hardware devices, operating systems, virtualization layers, guest operating systems, and applications, among other types of log/event-message sources. The message collectors generally accumulate a number of log/event messages, compress them using any of commonly available data-compression methods, and send the compressed batches of log/event messages to a message-ingestion-and-processing component 1408. The message-ingestion-and-processing component decompresses received batches of messages, carry out any of various types of message processing, such as generating alerts for particular types of messages, filtering the messages, and normalizing the messages, prior to streaming certain of the log/event messages to one or more stream destinations 1409 and storing some or all of the messages in a message database 1410. A log/event-message query-processing subsystem 1412 receives queries from distributed-computer-system administrators and managers, as well as from automated administration-and-management systems, and accesses the message database 1410 to retrieve stored log/event messages and/or information extracted from log/event messages specified by the receive queries for return to the distributed-computer-system administrators and managers and automated administration-and-management systems.

FIG. 14B illustrates three different, concurrently operating log/event-message subsystems within a log/event-message system within a distributed computer system. The three different log/event-message subsystems 1420-1422 share the architecture discussed above with reference to FIG. 14A. All three log/event-message subsystems stream log/event messages to one or more stream destinations 1424. In certain cases two or more log/event-message subsystems may stream log/event messages to a common stream destination. In addition to query systems provided by each of the log/event-message subsystems 1426-1428, a higher-level aggregator provides a log/event-message query system 1430 that allows users to query log/event messages stored in all three log/event-message-subsystem specific databases 1432-1434.

As discussed above, enormous volumes of log/event messages are generated within modern distributed computer systems. As a result, message collectors are generally processor-bandwidth bound and network-bandwidth bound. The volume of log/event-message traffic can use a significant portion of the intra-system and inter-system networking bandwidth, decreasing the network bandwidth available to support client applications and data transfer between local applications as well as between local applications and remote computational entities. Loaded networks generally suffer significant message-transfer latencies, which can lead to significant latencies in processing log/event messages and generating alerts based on processed log/event messages and to delayed detection and diagnosis of potential and incipient operational anomalies within the distributed computer systems. Message collectors may use all or a significant portion of the network bandwidth and computational bandwidth of one or more servers within a distributed computer system, lowering the available computational bandwidth for executing client applications and services. Message-ingestion-and-processing systems are associated with similar network-bandwidth and processor-bandwidth overheads, but also use large amounts of data-storage capacities within the computing systems in which they reside. Because of the volume of log/event-message data stored within the message database, many of the more complex types of queries executed by the log/event-message query system against the stored log/event-message data may be associated with significant latencies and very high computational overheads. As the number of components within distributed computer systems increases, the network, processor-bandwidth, and storage-capacity overheads can end up representing significant portions of the total network bandwidth, computational bandwidth, and storage capacity of the distributed computer systems that generate log/event messages.

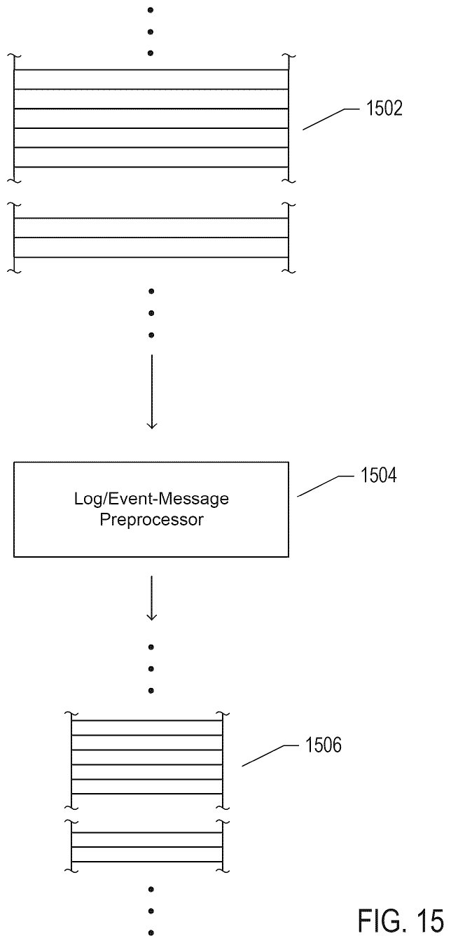

One approach to addressing the above-discussed problems is to attempt to preprocess log/event messages in ways that decrease the volume of data in a log/event-message stream. FIG. 15 illustrates log/event-message preprocessing. As shown in FIG. 15, an input stream of log/event messages 1502 is preprocessed by a log/event-message preprocessor 1504 to generate an output stream 1506 of log/event messages that represents a significantly smaller volume of data. Preprocessing may include filtering received log/event messages, compressing received log/event messages, and applying other such operations to received log/event messages that result in a decrease in the data volume represented by the stream of log/event messages output from the preprocessing steps.

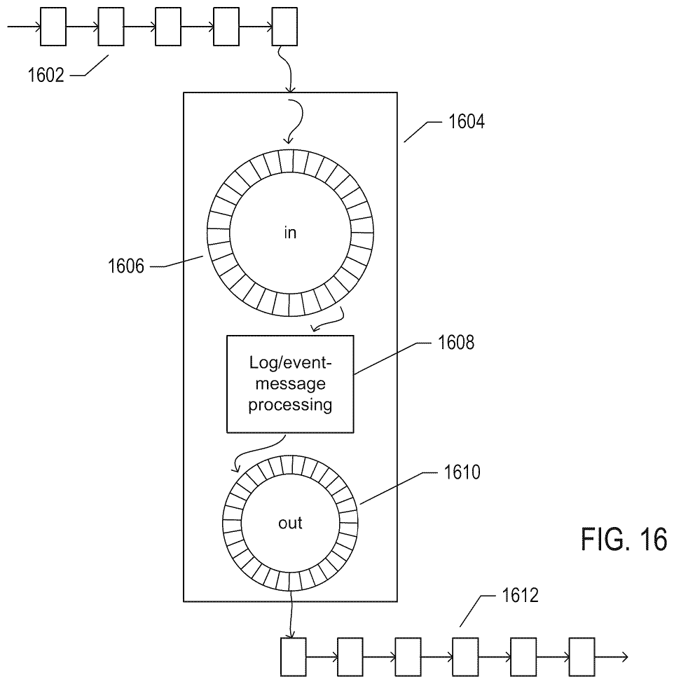

FIG. 16 illustrates processing of log/event messages by a message-collector component or a message-ingestion-and-processing component. An input stream of event/log messages 1602 is received by a communications subsystem of the component 1604 and placed in an input queue 1606. Log/event-message processing functionality 1608 processes log/event messages removed from the input queue and places resulting processed log/event messages for transmission to downstream processing components in an output queue 1610. The communications subsystem of the component removes processed log/event messages from the output queue and transmits them via electronic communications to downstream processing components as an output log/event-message stream 1612. Downstream components for message-collector systems primarily include message-ingestion-and-processing components, but may include additional targets, or destinations, to which log/event-messages are forwarded or to which alerts and notifications are forwarded. Downstream components for message-ingestion-and-processing components primarily include log/event-message query systems, which store log/event messages for subsequent retrieval by analytics systems and other log/event-message-consuming systems within a distributed computer system, but may also include additional targets, or destinations, to which log/event-messages are forwarded or to which alerts and notifications are forwarded as well as long-term archival systems.

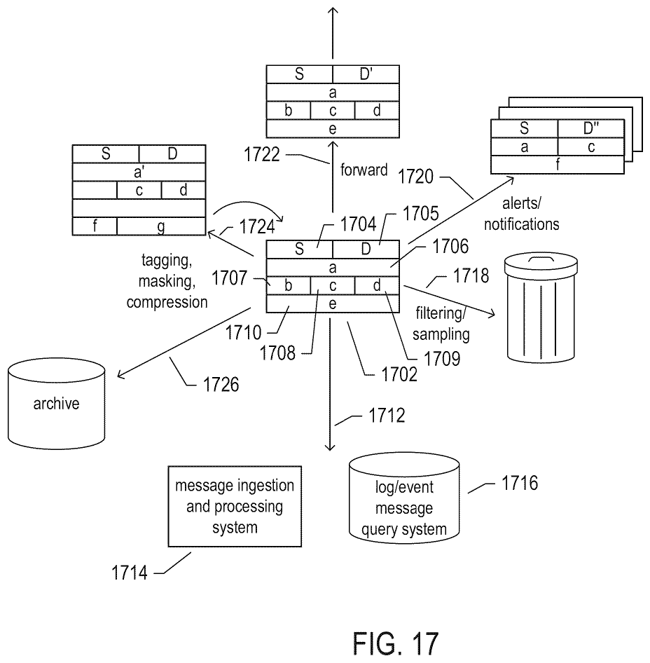

FIG. 17 illustrates various common types of initial log/event-message processing carried out by message-collector components and/or message-ingestion-and-processing components. A received log/event message 1702 is shown in the center of FIG. 17. In this example, the message contains source and destination addresses 1704-1705 in a message header as well as five variable fields 1706-1710 with field values indicated by the symbols “a.” “b.” “c.” “d.” and “c.” respectively. The message is generally transmitted to a downstream processing component, as represented by arrow 1712, where downstream processing components include a message-ingestion-and-processing component 1714 and a log/event-message query system 1760. Transmission of the message to a downstream processing component occurs unless a processing rule specifies that the transmission should not occur. Alternatively, the message may be dropped, as indicated by arrow 1718, due to a filtering or sampling action contained in a processing rule. Sampling involves processing only a specified percentage p of log/event messages of a particular type or class and dropping the remaining 1−p percentage of the log/event messages of the particular type or class. Filtering involves dropping, or discarding, those log/event messages that meet a specified criteria. Rules may specify that various types of alerts and notifications are to be generated, as a result of reception of a message to which the rule applies, for transmission to target destinations specified by the parameters of the rule, as indicated by arrow 1720. As indicated by arrow 1722, a received log/event message may be forwarded to a different or additional target destinations when indicated by the criteria associated with a processing rule. As indicated by arrow 1724, processing rules may specify that received log/event messages that meet specified criteria should be modified before subsequent processing steps. The modification may involve tagging, in which information is added to the message, masking, which involves altering field values within the message to prevent access to the original values during subsequent message processing, and compression, which may involve deleting or abbreviating fields within the received log/event message. Arrow 1726 indicates that a rule may specify that a received message is to be forwarded to a long-term archival system. These are but examples of various types of initial log/event-message processing steps that may be carried out by message collectors and/or message-ingestion-and-processing components when specified by applicable rules.

### Circular Queues

In FIG. 16, the input 1606 and output 1610 queues are shown to be implemented as circular queues. There are many different types of buffers and queues that can be used to implement the input and output queues, but circular queues are commonly used in such cases. They are simple to implement and have certain characteristics and features that are particularly useful in particular problem domains. FIG. 18 illustrates operation of a circular queue. The initial state of a circular queue is represented by the first snapshot of the circular queue 1802 in FIG. 18. In this initial state, the circular queue is empty. A circular queue is associated with two pointers in 1803 and out 1804. The in pointer points to the slot into which a next entry can be entered and the out pointer points to a slot from which a next entry can be removed from the circular queue. Entries are generally removed in first-in/first-out order. When both the in and out pointers point to the same slot, the circular queue is empty. The slots in the circular queue generally have fixed sizes. Variable-sized entries can be accommodated by referencing the contents of the entries, stored in one or more memory buffers, from pointers stored in slots of a circular queue or by using slot sizes large enough to store any possible entry.

In FIG. 18, entries are represented by monotonically increasing integers, for convenience of illustration. An initial put operation, which stores a first entry represented by the integer “1,” is represented by curved arrow 1806. The put operation results in a next state of the circular queue represented by circular queue 1808. This same illustration convention is used repeatedly in FIG. 18 to illustrate a sequence of operations and resulting states. The initial put operation 1806 places the entry into slot 1809, previously pointed to by the in pointer in the initial state of the circular queue 1802, and advances the in pointer to point to the next slot 1810 in the circular queue. A second input operation 1812 results in storage of the next entry “2” in slot 1810 and advancement of the in pointer to point to slot 1813. A get operation, which retrieves the next available entry from the circular queue, is next carried out, as represented by curved arrow 1815. The get operation retrieves the entry in slot 1809 represented by the integer “1.” and advances the out pointer to slot 1810. A subsequent get operation retrieves entry “2” from the circular queue and advances the out pointer to slot 1813, as shown in circular-Q state 1818. The circular queue is again empty. When a next get operation is attempted, as represented by curved arrow 1820, an error is returned since the circular queue is empty and there are no entries in the circular queue available for retrieval. The state 1821 of the circular queue is unchanged. A put operation 1822 places entry “3” into the circular queue and advances the in pointer, as shown in circular-queue state 1823, and a second input operation 1824 fills the circular queue, as shown by circular-queue state 1825. A next put operation, represented by curved arrow 1827 fails, since the circular queue is already full. Note that there is one empty slot referenced by the in pointer in a completely filled circular queue. Several get operations 1830 place the circular queue in state 1832. An additional put operation 1834 places the circular queue in state 1836, and two additional get operations 1838 place the circular queue in state 1840.

The circular queue operates as a buffer that allows a first asynchronous process to place entries into the circular queue while a second asynchronous process removes entries from the circular queue. This allows the two asynchronous processes to operate at different speeds. When the first asynchronous process is adding countries to the circular queue faster than the second asynchronous process removes them, the number of entries in the queue increases, thus buffering the disparity in the operational speeds of the two asynchronous processes. Subsequently, the second asynchronous process may remove entries from the circular queue faster than the first asynchronous process as entries to the circular queue, which decreases the total number of entries stored in the circular queue.

FIG. 19 illustrates an implementation of a circular queue. A linear buffer comprising a sequence of storage cells or slots in a memory 1902 is used to implement the circular queue. The first storage cell 1904 has the memory address b, the base address for the linear buffer. As indicated by expression 1906, the address of each additional queue slot is computed by adding the product of a monotonically increasing index and the fixed size of the queue slots to the base address. In the example shown in FIG. 19, each queue slot comprises eight bytes of memory. As shown by expression 1908, the indexes range from 0 to one less than the total number of slots in the linear buffer. The linear buffer is transformed into a circular buffer using modulo arithmetic. To illustrate this, each queue pointer, including the in pointer and the out pointer, is represented by a memory-pointer member 1910 and an index member 1912. In an actual implementation, an example of which is provided below, only a single memory pointer is needed. Pseudocode 1914 represents the increment operation for a queue pointer. This operation advances a queue pointer to the next slot, in the circular queue. When the index member of the queue pointer is equal to one less than the total number of slots in the linear buffer, as determined by the Boolean expression in the if statement 1916, the index is set to 0 and the memory-pointer number is set to the base address for the queue, in statements 1918. Otherwise, the index member is incremented, in statement 1920 and the pointer member is increased by the size of the queue slots in statement 1922. Thus, the increment operation for queue pointers advances a queue pointer along the linear buffer and then wraps around the linear buffer from the end of the linear buffer back to the beginning of the linear buffer. Pseudocode 1924 represents a decrement operation for a queue pointer. In this case, when the index has a value 0, as determined in the Boolean expression of the if statement 1926, the index is set to one less than the total number of slots in the linear buffer and the pointer member is set to the memory address of the last slot in the linear buffer, in statements 1928. Otherwise, the index member is decremented in statement 1929 and the pointer member is decremented by the queue-slot size in statement 1930. By defining the increment and decrement operations in this way, the linear buffer is converted into a circular buffer.

### Neural Networks

FIG. 20 illustrates fundamental components of a feed-forward neural network. Expressions 2002 mathematically represent ideal operation of a neural network as a function ƒ(x). The function receives an input vector x and outputs a corresponding output vector y 1103. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression of expressions 2002 represents the ideal operation of the neural network. In other words, the output vector y represents the ideal, or desired, output for corresponding input vector x. However, in actual operation, a physically implemented neural network \hat{ƒ}(x), as represented by the second expression of expressions 2002, returns a physically generated output vector ŷ that may differ from the ideal or desired output vector y. An output vector produced by the physically implemented neural network is associated with an error or loss value. A common error or loss value is the square of the distance between the two points represented by the ideal output vector y and the output vector produced by the neural network ŷ. The distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 2006 of FIG. 20, a feed-forward neural network generally consists of layers of nodes, including an input layer 2008, an output layer 2010, and one or more hidden layers 2012. These layers can be numerically labeled 1, 2, 3, . . . , L−1, L, as shown in FIG. 20. In general, the input layer contains a node for each element of the input vector and the output layer contains one node for each element of the output vector. The input layer and/or output layer may each have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph, as indicated by line segments, such as line segment 2014.

The lower portion of FIG. 20 (2020 in FIG. 20) illustrates a feed-forward neural-network node. The neural-network node 2022 receives inputs 2024-2027 from one or more next-higher-level nodes and generates an output 2028 that is distributed to one or more next-lower-level nodes 2030. The inputs and outputs are referred to as “activations,” represented by superscripted-and-subscripted symbols “a” in FIG. 20, such as the activation symbol 2024. An input component 2036 within a node collects the input activations and generates a weighted sum of these input activations to which a weighted internal activation a₀ is added. An activation component 2038 within the node is represented by a function g( ), referred to as an “activation function,” that is used in an output component 2040 of the node to generate the output activation of the node based on the input collected by the input component 2036. The neural-network node 2022 represents a generic hidden-layer node. Input-layer nodes lack the input component 2036 and each receive a single input value representing an element of an input vector. Output-component nodes output a single value representing an element of the output vector. The values of the weights used to generate the cumulative input by the input component 2036 are determined by training, as previously mentioned. In general, the input, outputs, and activation function are predetermined and constant, although, in certain types of neural networks, these may also be at least partly adjustable parameters. In FIG. 20, three different possible activation functions are indicated by expressions 2042-2044. The first expression is a binary activation function and the third expression represents a sigmoidal relationship between input and output that is commonly used in neural networks and other types of machine-learning systems, both functions producing an activation in the range [0, 1]. The second function is also sigmoidal, but produces an activation in the range [−1, 1].

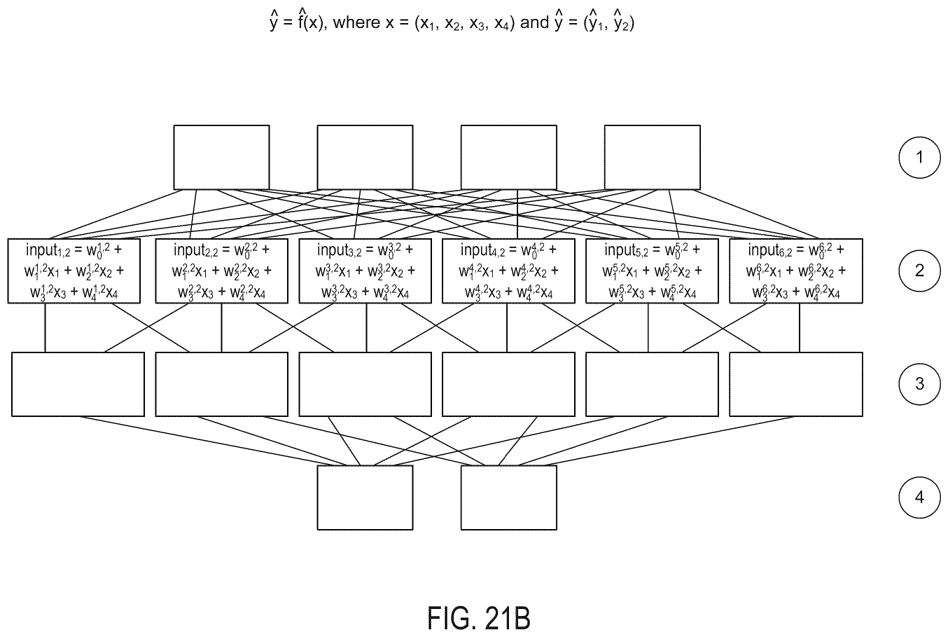

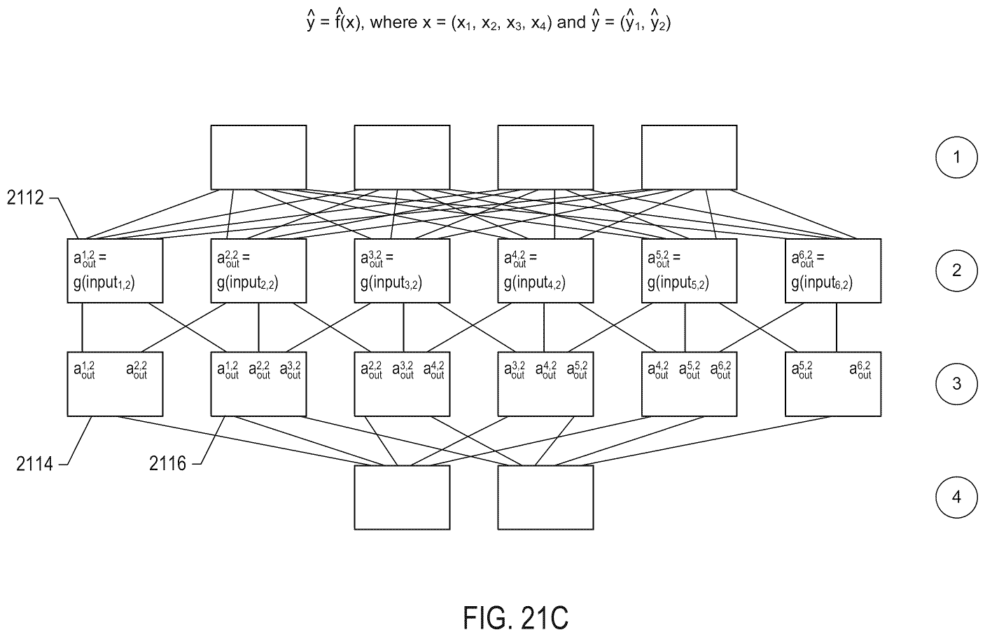

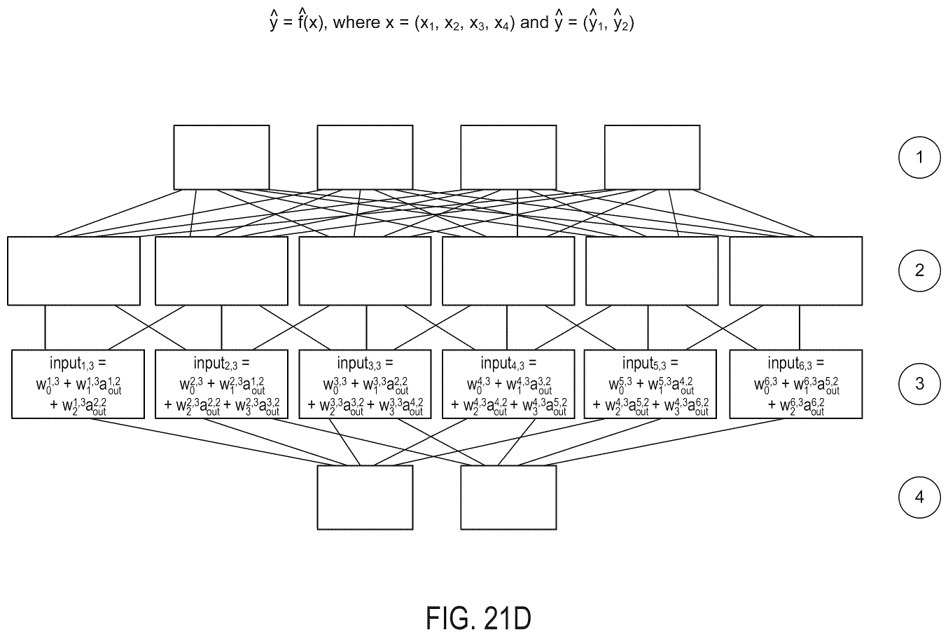

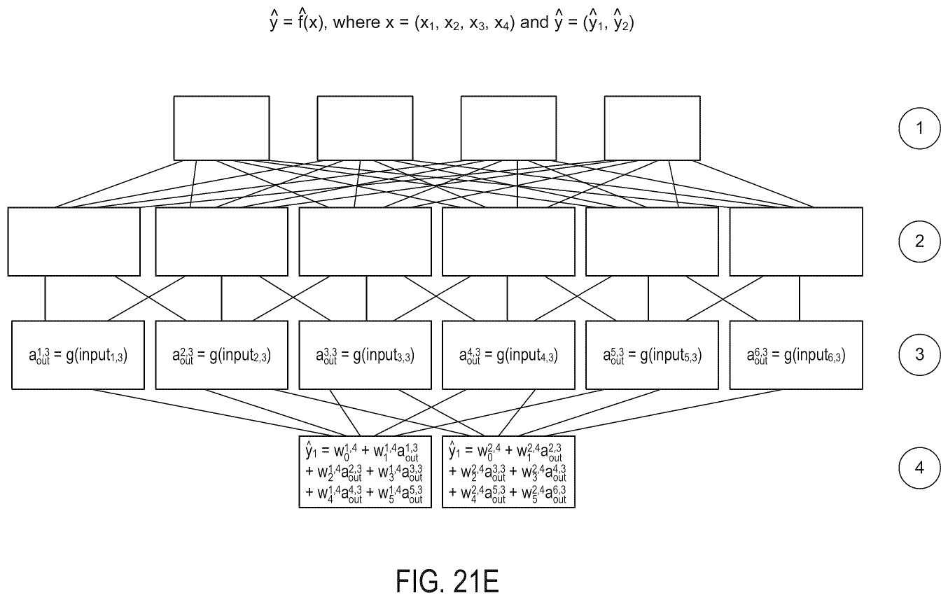

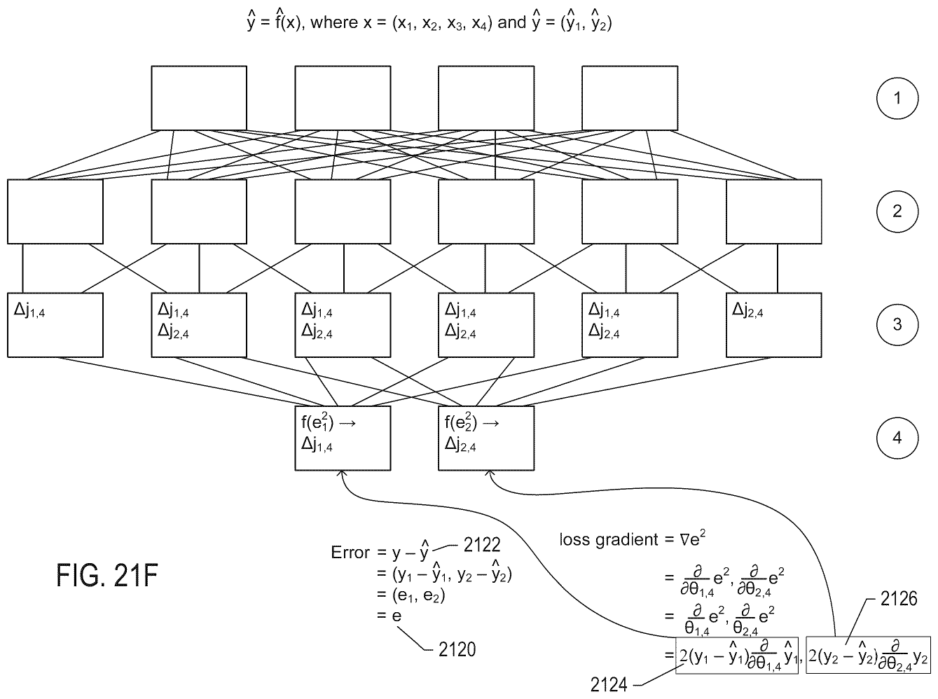

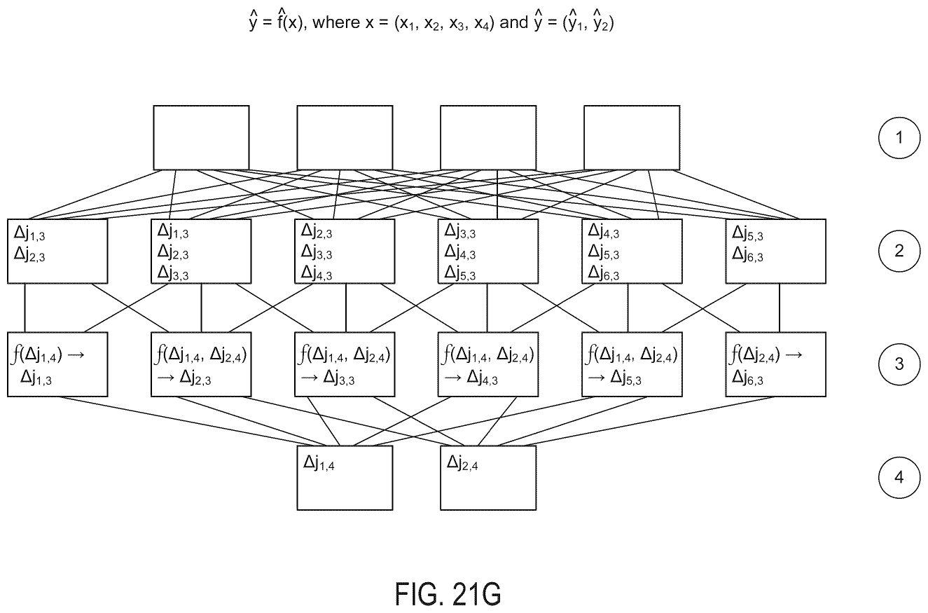

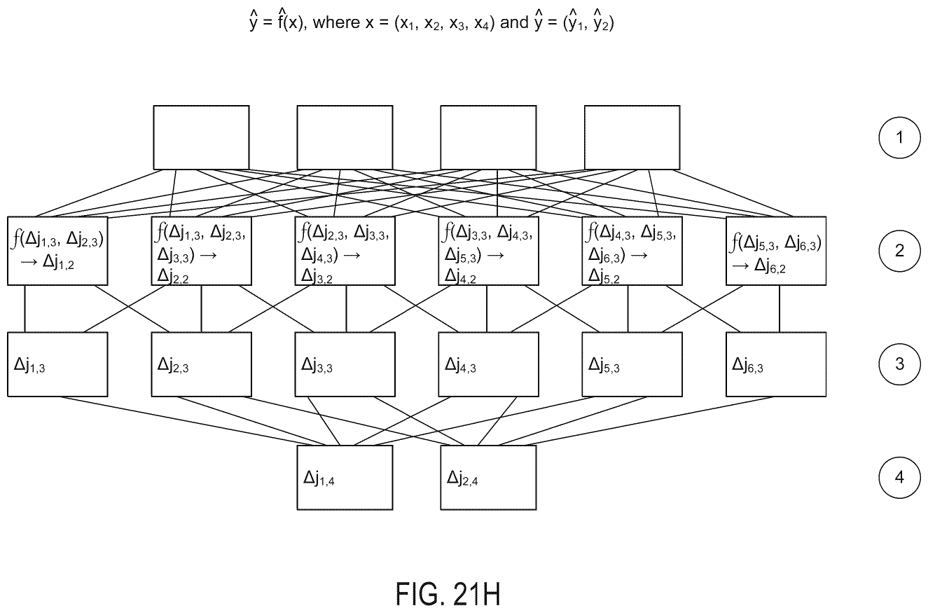

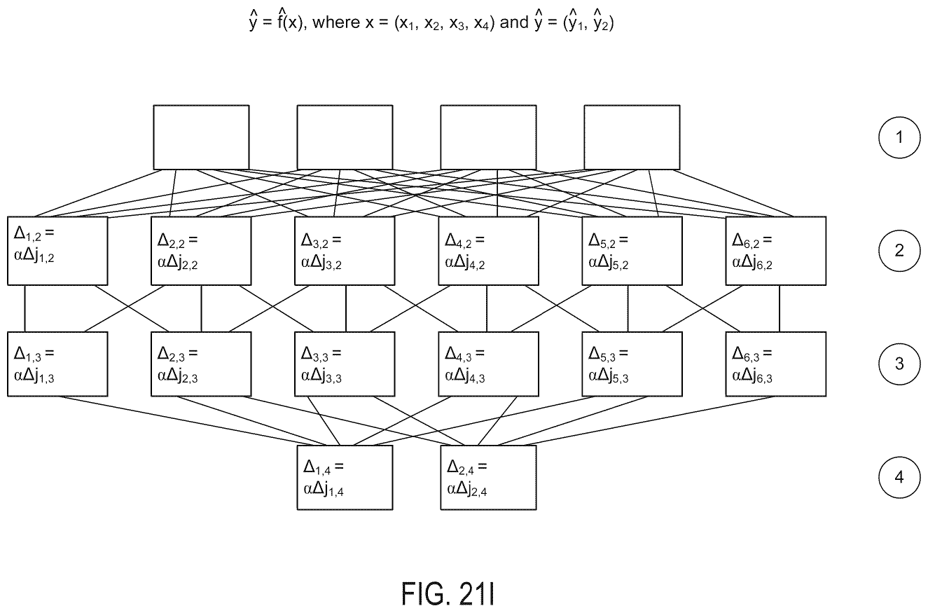

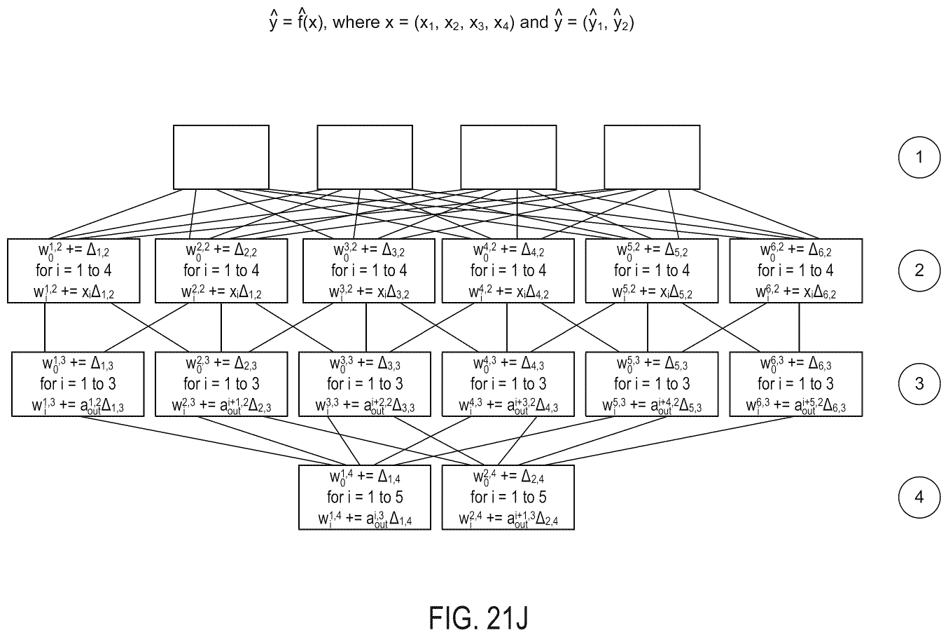

FIGS. 21A-J illustrate operation of a very small, example neural network. The example neural network has four input nodes in a first layer 2102, six nodes in a first hidden layer 2104 six nodes in a second hidden layer 2106, and two output nodes 2108. As shown in FIG. 21A, the four elements of the input vector x 2110 are each input to one of the four input nodes which then output these input values to the nodes of the first-hidden layer to which they are connected. In the example neural network, each input node is connected to all of the nodes in the first hidden layer. As a result, each node in the first hidden layer has received the four input-vector elements, as indicated in FIG. 21A. As shown in FIG. 21B, each of the first-hidden-layer nodes computes a weighted-sum input according to the expression contained in the input components (2036 in FIG. 20) of the first hidden-layer nodes. Note that, although each first-hidden-layer node receives the same four input-vector elements, the weighted-sum input computed by each first-hidden-layer node is generally different from the weighted-sum inputs computed by the other first-hidden-layer nodes, since each first-hidden-layer node generally uses a set of weights unique to the first-hidden-layer node. As shown in FIG. 21C, the activation component (2038 in FIG. 20) of each of the first-hidden-layer nodes next computes an activation and then outputs the computed activation to each of the second-hidden-layer nodes to which the first-hidden-layer node is connected. Thus, for example, the first-hidden-layer node 2112 computes activation aₒᵤₜ^{1,2} using the activation function and outputs this activation to second-hidden-layer nodes 2114 and 2116. As shown in FIG. 21D, the input components (2036 in FIG. 20) of the second-hidden-layer nodes compute weighted-sum inputs from the activations received from the first-hidden-layer nodes to which they are connected and then, as shown in FIG. 21E, compute activations from the weighted-sum inputs and output the activations to the output-layer nodes to which they are connected. The output-layer nodes compute weighted sums of the inputs and then output those weighted sums as elements of the output vector.

FIG. 21F illustrates backpropagation of an error computed for an output vector. Backpropagation of a loss in the reverse direction through the neural network results in a change in some or all of the neural-network-node weights and is the mechanism by which a neural network is trained. The error vector e 2120 is computed as the difference between the desired output vector y and the output vector ŷ (2122 in FIG. 21F) produced by the neural network in response to input of the vector x. The output-layer nodes each receive a squared element of the error vector and compute a component of a gradient of the squared length of the error vector with respect to the parameters θ of the neural-network, which are the weights. Thus, in the current example, the squared length of the error vector e is equal to |e|² or e₁²+e₂², and the loss gradient is equal to:

$${∇}_{θ} ( {e}_{1}^{2} + {e}_{2}^{2} ) = \frac{\partial }{\partial θ} {e}_{1}^{2} , \frac{\partial }{\partial θ} {e}_{2}^{2} .$$

Since each output-layer neural-network node represents one dimension of the multi-dimensional output, each output-layer neural-network node receives one term of the squared distance of the error vector and computes the partial differential of that term with respect to the parameters, or weights, of the output-layer neural-network node. Thus, the first output-layer neural-network node receives e₁² and computes

$$\frac{\partial }{\partial {θ}_{1 , 4}} {e}_{1}^{2} ,$$

where the subscript 1,4 indicates parameters for the first node of the fourth, or output, layer. The output-layer neural-network nodes then compute this partial derivative, as indicated by expressions 2124 and 2126 in FIG. 21F. The computations are discussed later. However, to follow the backpropagation diagrammatically, each node of the output layer receives a term of the squared length of the error vector which is input to a function that returns a weight adjustment Δⱼ. As shown in FIG. 21F, the weight adjustment computed by each of the output nodes is back propagated upward to the second-hidden-layer nodes to which the output node is connected. Next, as shown in FIG. 21G, each of the second-hidden-layer nodes computes a weight adjustment Δⱼ from the weight adjustments received from the output-layer nodes and propagates the computed weight adjustments upward in the neural network to the first-hidden-layer nodes to which the second-hidden-layer node is connected. Finally, as shown in FIG. 21H, the first-hidden-layer nodes computes weight adjustments based on the weight adjustments received from the second-hidden-layer nodes. These weight adjustments are not, however, back propagated further upward in the neural network since the input-layer nodes do not compute weighted sums of input activations, instead each receiving only a single element of the input vector x.

In a next logical step, shown in FIG. 21I, the computed weight adjustments are multiplied by a learning constant α to produce final weight adjustments Δ for each node in the neural network. In general, each final weight adjustment is specific and unique for each neural-network node, since each weight adjustment is computed based on a node's weights and the weights of lower-level nodes connected to a node via a path in the neural network. The logical step shown in FIG. 21I is not, in practice, a separate discrete step since the final weight adjustments can be computed immediately following computation of the initial weight adjustment by each node. Similarly, as shown in FIG. 21J, in a final logical step, each node adjusts its weights using the computed final weight adjustment for the node. Again, this final logical step is, in practice, not a discrete separate step since a node can adjust its weights as soon as the final weight adjustment for the node is computed. It should be noted that the weight adjustment made by each node involves both the final weight adjustment computed by the node as well as the inputs received by the node during computation of the output vector ŷ from which the error vector e was computed, as discussed above with reference to FIG. 21F. The weight adjustment carried out by each node shift the weights in each node toward producing an output that, together with the outputs produced by all the other nodes following weight adjustment, results in decreasing the distance between the desired output vector y and the output vector ŷ that would now be produced by the neural network in response to receiving the input vector x. In many neural-network implementations, it is possible to make batched adjustments to the neural-network weights based on multiple output vectors produced from multiple inputs, as discussed further below.

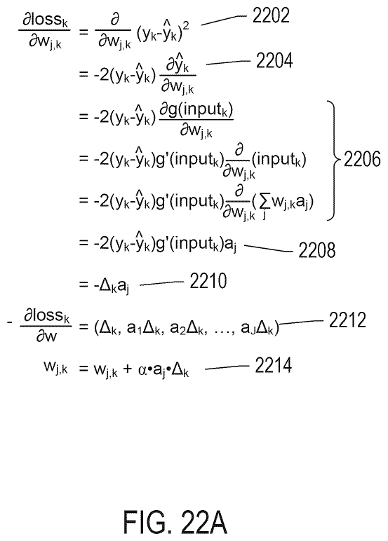

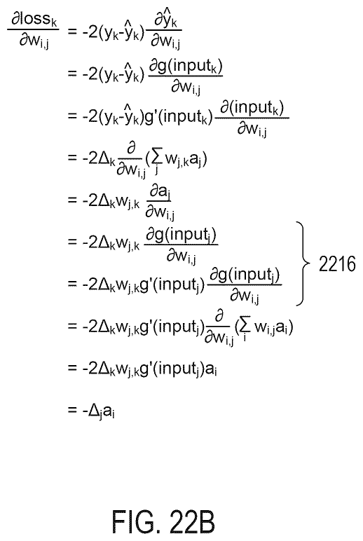

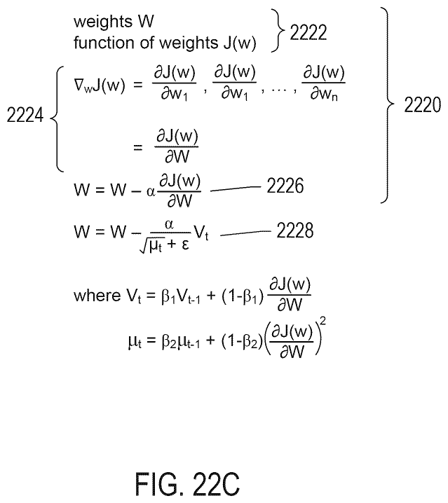

FIGS. 22A-C show details of the computation of weight adjustments made by neural-network nodes during backpropagation of error vectors into neural networks. The expression 2202 in FIG. 22A represents the partial differential of the loss, or k^{th} component of the squared length of the error vector eₖ², computed by the k^{th} output-layer neural-network node with respect to the J+1 weights applied to the formal 0^{th} input a₀ and inputs a₁-a_{J} received from higher-level nodes. Application of the chain rule for partial differentiation produces expression 2204. Substitution of the activation function for y, in the second application of the chain rule produces expressions 2206. The partial differential of the sum of weighted activations with respect to the weight for activation j is simply activation j, aⱼ, generating expression 2208. The initial factors in expression 2208 are replaced by −Δₖ to produce a final expression for the partial differential of the k^{th} component of the loss with respect to the j^{th} weight, 2210. The negative gradient of the weight adjustments is used in backpropagation in order to minimize the loss, as indicated by expression 2212. Thus, the j^{th} weight for the k^{th} output-layer neural-network node is adjusted according to expression 2214, where a is a learning-rate constant in the range [0,1].

FIG. 22B illustrates computation of the weight adjustment for the kth component of the error vector in a final-hidden-layer neural-network node. This computation is similar to that discussed above with reference to FIG. 22A, but includes an additional application of the chain rule for partial differentiation in expressions 2216 in order to obtain an expression for the partial differential with respect to a second-hidden-layer-node weight that includes an output-layer-node weight adjustment.

FIG. 22C illustrates one commonly used improvement over the above-described weight-adjustment computations. The above-described weight-adjustment computations are summarized in expressions 2220. There is a set of weights W and a function of the weights J(W), as indicated by expressions 2222. The backpropagation of errors through the neural network is based on the gradient, with respect to the weights, of the function J(W), as indicated by expressions 2224. The weight adjustment is represented by expression 2226, in which a learning constant times the gradient of the function J(W) is subtracted from the weights to generate the new, adjusted weights. In the improvement illustrated in FIG. 22C, expression 2226 is modified to produce expression 2228 for the weight adjustment. In the improved weight adjustment, the learning constant α is divided by the sum of a weighted average of adjustments and a very small additional term ε and the gradient is replaced by the factor Vₜ, where t represents time or, equivalently, the current weight adjustment in a series of weight adjustments. The factor Vₜ is a combination of the factor for the preceding time point or weight adjustment Vₜ₋₁ and the gradient computed for the current time point or weight adjustment. This factor is intended to add momentum to the gradient descent in order to avoid premature completion of the gradient-descent process at a local minimum. Division of the learning constant α by the weighted average of adjustments adjusts the learning rate over the course of the gradient descent so that the gradient descent converges in a reasonable period of time.

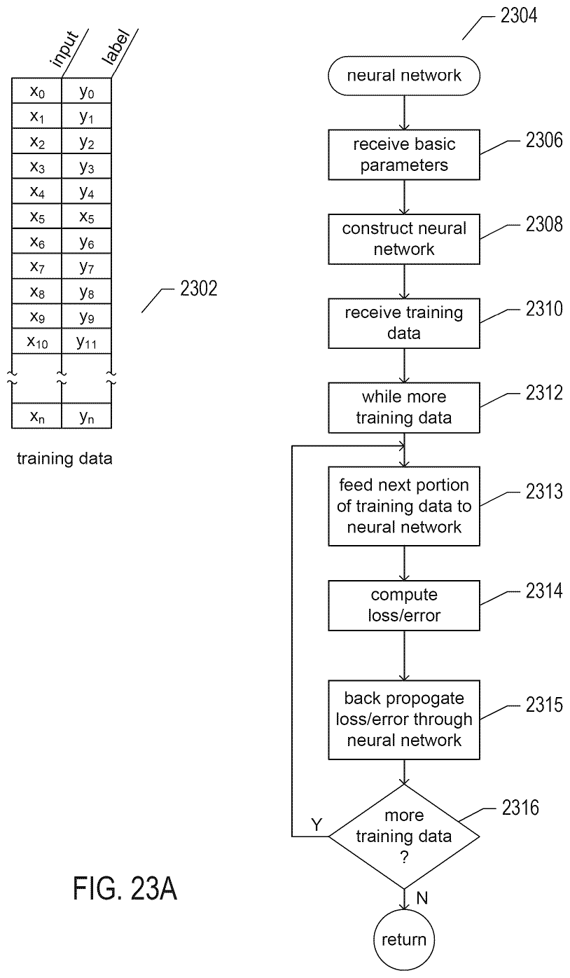

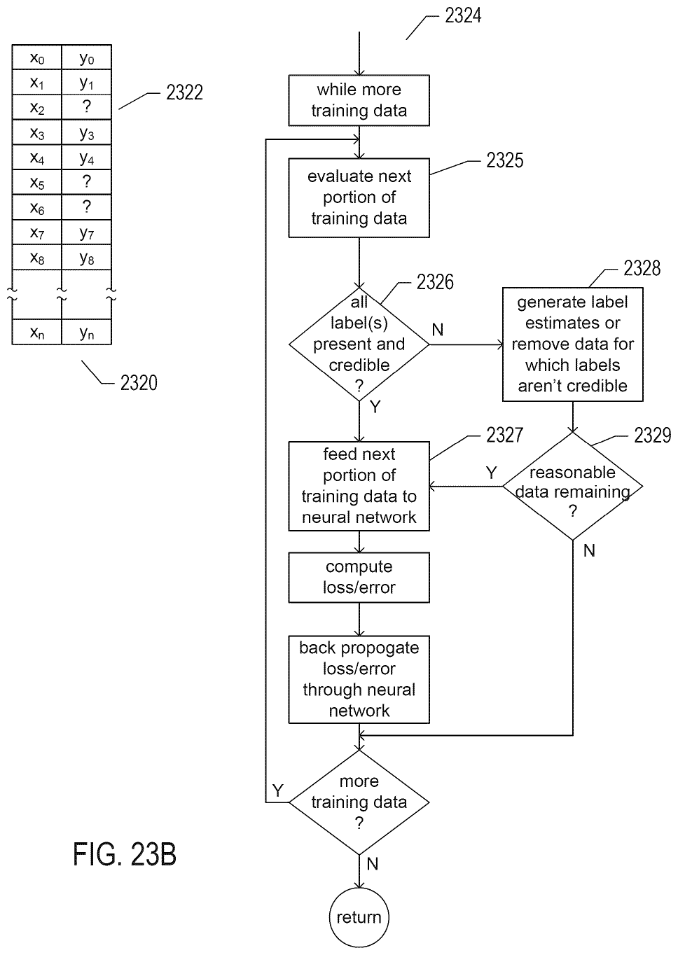

FIGS. 23A-B illustrate neural-network training. FIG. 23A illustrates the construction and training of a neural network using a complete and accurate training dataset. The training dataset is shown as a table of input-vector/label pairs 2302, in which each row represents an input-vector/label pair. The control-flow diagram 2304 illustrates construction and training of a neural network using the training dataset. In step 2306, basic parameters for the neural network are received, such as the number of layers, number of nodes in each layer, node interconnections, and activation functions. In step 2308, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 2310, training data represented by table 2302 is received. Then, in the while-loop of steps 2312-2316, portions of the training data are iteratively input to the neural network, in step 2313, the loss or error is computed, in step 2314, and the computed loss or error is back-propagated through the neural network step 2315 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 23B illustrates one method of training a neural network using an incomplete training dataset. Table 2320 represents the incomplete training dataset. For certain of the input-vector/label pairs, the label is represented by a “?” symbol, such as in the input-vector/label pair 2322. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 2324 illustrates alterations in the while-loop of steps 2312-2316 in FIG. 23A that might be employed to train the neural network using the incomplete training dataset. In step 2325, a next portion of the training dataset is evaluated to determine the status of the labels in the next portion of the training data. When all of the labels are present and credible, as determined in step 2326, the next portion of the training dataset is input to the neural network, in step 2327, as in FIG. 23A. However, when certain labels are missing or lack credibility, as determined in step 2326, the input-vector/label pairs that include those labels are removed or altered to include better estimates of the label values, in step 2328. When there is reasonable training data remaining in the training-data portion following step 2328, as determined in step 2329, the remaining reasonable data is input to the neural network in step 2327. The remaining steps in the while-loop are equivalent to those in the control-flow diagram shown in FIG. 23A. Thus, in this approach, either suspect data is removed, or better labels are estimated, based on various criteria, for substitution for the suspect labels.

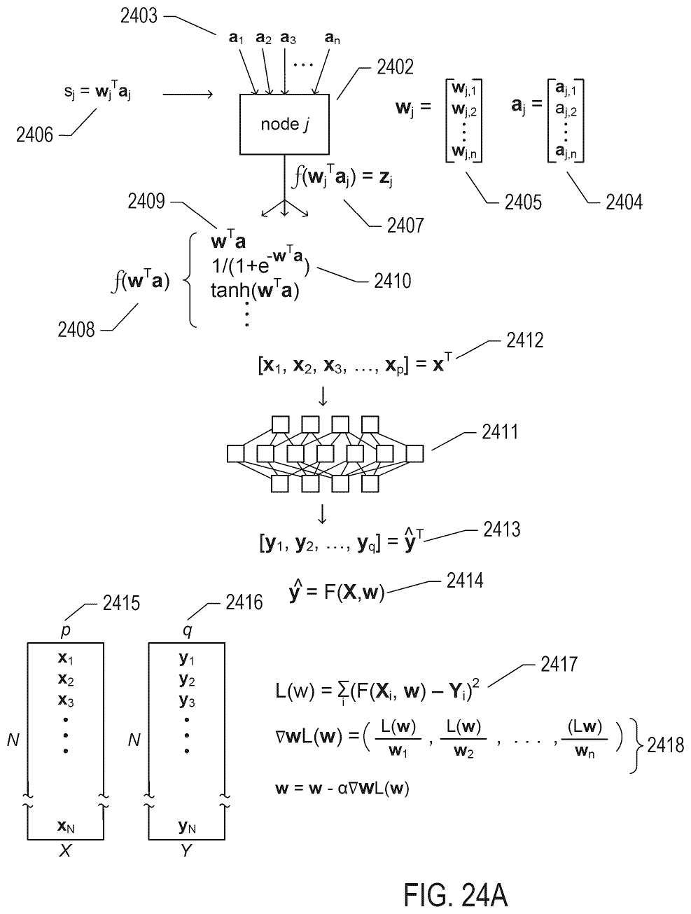

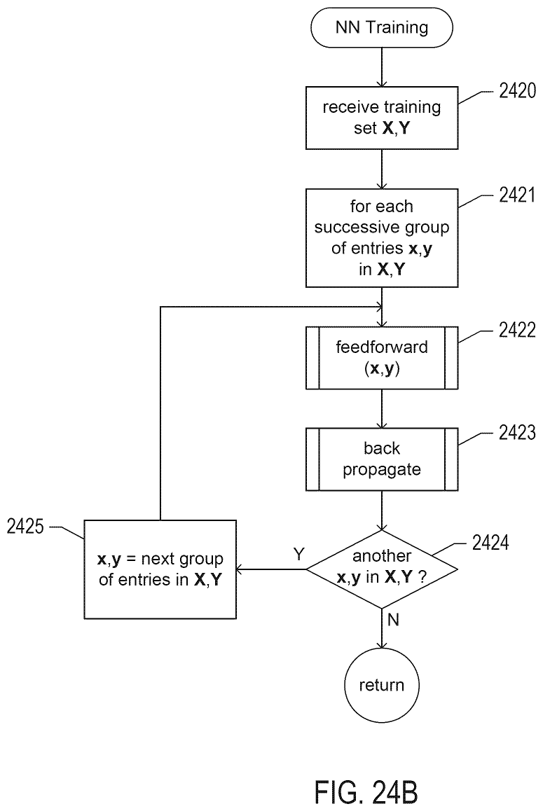

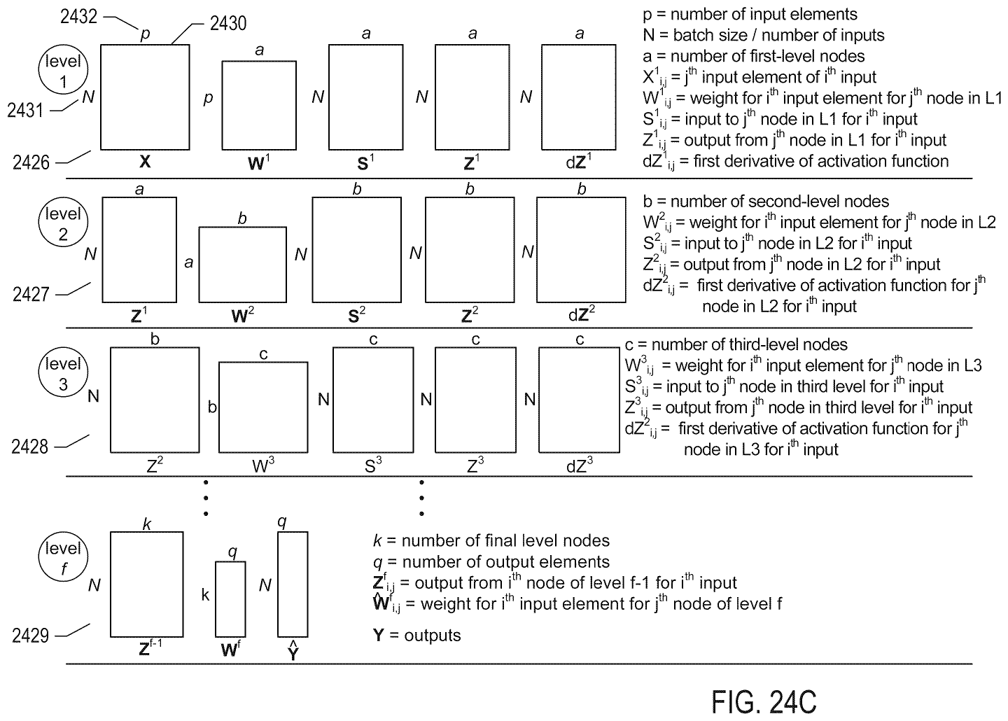

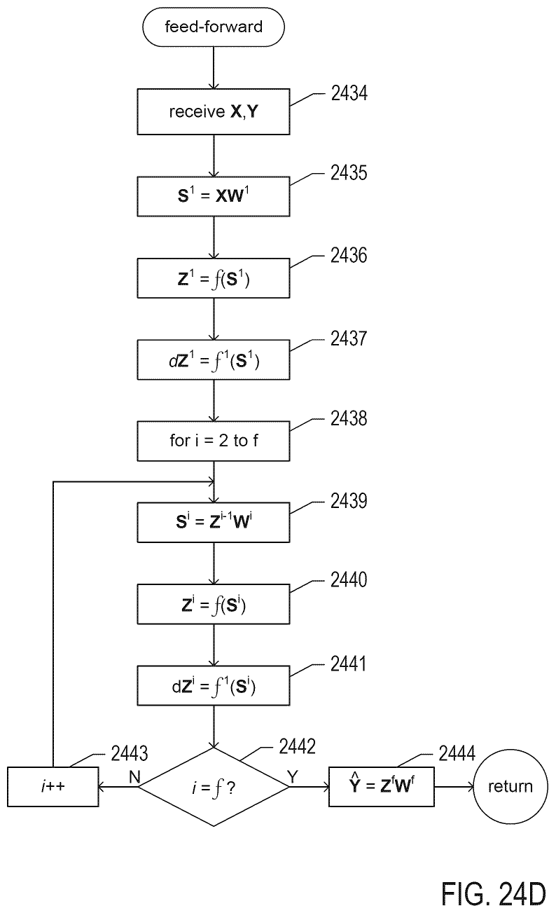

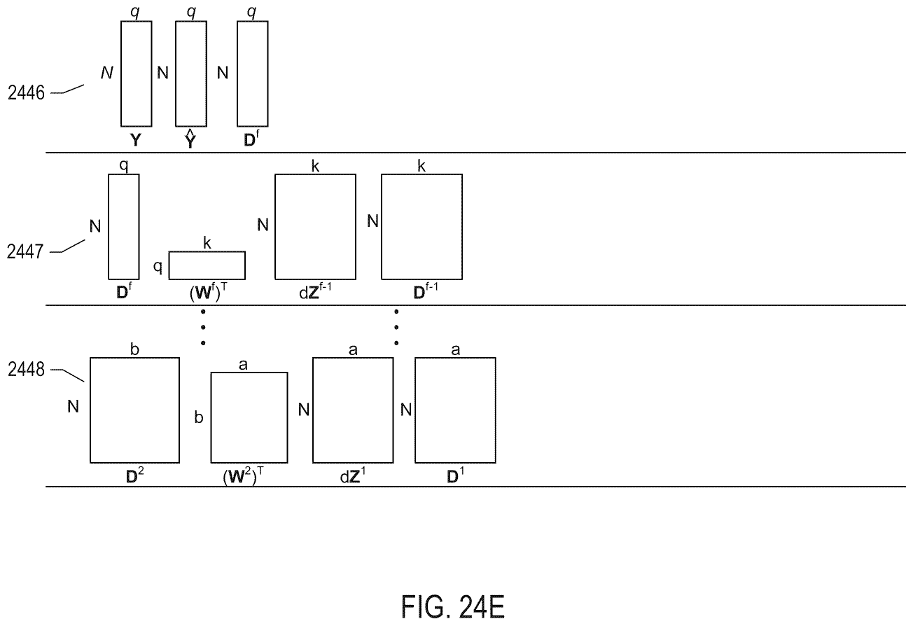

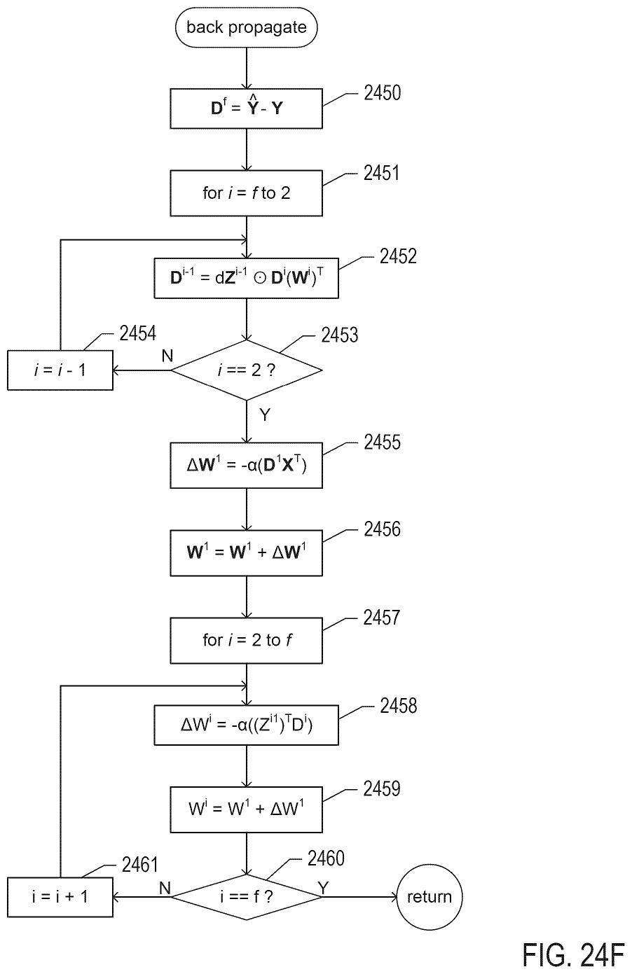

FIGS. 24A-F illustrate a matrix-operation-based batch method for neural-network training. This method processes batches of training data and losses to efficiently train a neural network. FIG. 24A illustrates the neural network and associated terminology. As discussed above, each node in the neural network, such as node j 2402, receives one or more inputs a 2403, expressed as a vector aⱼ 2404, that are multiplied by corresponding weights, expressed as a vector wⱼ 2405, and added together to produce an input signal sⱼ using a vector dot-product operation 2406. An activation function ƒ within the node receives the input signal sⱼ and generates an output signal zⱼ 2407 that is output to all child nodes of node j. Expression 2408 provides an example of various types of activation functions that may be used in the neural network. These include a linear activation function 2409 and a sigmoidal activation function 2410. As discussed above, the neural network 2411 receives a vector of p input values 2412 and outputs a vector of q output values 2413. In other words, the neural network can be thought of as a function F 2414 that receives a vector of input values x^{T} and uses a current set of weights w within the nodes of the neural network to produce a vector of output values ŷ^{T}. The neural network is trained using a training data set comprising a matrix X 2415 of input values, each of N rows in the matrix corresponding to an input vector x^{T}, and a matrix Y 2416 of desired output values, or labels, each of N rows in the matrix corresponding to a desired output-value vector y^{T}. A least-squares loss function is used in training 2417 with the weights updated using a gradient vector generated from the loss function, as indicated in expressions 2418, where a is a constant that corresponds to a learning rate.

FIG. 24B provides a control-flow diagram illustrating the method of neural-network training. In step 2420, the routine “NNTraining” receives the training set comprising matrices X and Y. Then, in the for-loop of steps 2421-2425, the routine “NNTraining” processes successive groups or batches of entries x and y selected from the training set. In step 2422, the routine “NNTraining” calls a routine “feedforward” to process the current batch of entries to generate outputs and, in step 2423, calls a routine “back propagated” to propagate errors back through the neural network in order to adjust the weights associated with each node.

FIG. 24C illustrates various matrices used in the routine “feedforward.” FIG. 24C is divided horizontally into four regions 2426-2429. Region 2426 approximately corresponds to the input level, regions 2427-2428 approximately correspond to hidden-node levels, and region 2429 approximately corresponds to the final output level. The various matrices are represented, in FIG. 24C, as rectangles, such as rectangle 2430 representing the input matrix X. The row and column dimensions of each matrix are indicated, such as the row dimension N 2431 and the column dimension p 2432 for input matrix X 2430. In the right-hand portion of each region in FIG. 24C, descriptions of the matrix-dimension values and matrix elements are provided. In short, the matrices W^{x} represent the weights associated with the nodes at level x, the matrices S^{x} represent the input signals associated with the nodes at level x, the matrices Z^{x} represent the outputs from the nodes at level x, and the matrices dZ^{x} represent the first derivative of the activation function for the nodes at level x evaluated for the input signals.

FIG. 24D provides a control-flow diagram for the routine “feedforward,” called in step 2422 of FIG. 24B. In step 2434, the routine “feedforward” receives a set of training data x and y selected from the training-data matrices X and Y. In step 2435, the routine “feedforward” computes the input signals S¹ for the first layer of nodes by matrix multiplication of matrices x and W¹, where matrix W¹ contains the weights associated with the first-layer nodes. In step 2436, the routine “feedforward” computes the output signals Z¹ for the first-layer nodes by applying a vector-based activation function ƒ to the input signals S¹. In step 2437, the routine “feedforward” computes the values of the derivatives of the activation function ƒ′, dZ¹. Then, in the for-loop of steps 2438-2443, the routine “feedforward” computes the input signals Sⁱ, the output signals Zⁱ, and the derivatives of the activation function dZⁱ for the nodes of the remaining levels of the neural network. Following completion of the for-loop of steps 2438-2443, the routine “feedforward” computes the output values ŷ^{T} for the received set of training data.

FIG. 24E illustrates various matrices used in the routine “back propagate.” FIG. 24E uses similar illustration conventions as used in FIG. 24C, and is also divided horizontally into horizontal regions 2446-2448. Region 2446 approximately corresponds to the output level, region 2447 approximately corresponds to hidden-node levels, and region 2448 approximately corresponds to the first node level. The only new type of matrix shown in FIG. 24E are the matrices D^{x} for node levels x. These matrices contain the error signals that are used to adjust the weights of the nodes.

FIG. 24F provides a control-flow diagram for the routine “back propagate.” In step 2450, the routine “back propagate” computes the first error-signal matrix D^{f} as the difference between the values ŷ output during a previous execution of the routine “feedforward” and the desired output values from the training set y. Then, in a for-loop of steps 2451-2454, the routine “back propagate” computes the remaining error-signal matrices for each of the node levels up to the first node level as the Shur product of the dZ matrix and the product of the transpose of the W matrix and the error-signal matrix for the next lower node level. In step 2455, the routine “back propagate” computes weight adjustments ΔW for the first-level nodes as the negative of the constant α times the product of the transpose of the input-value matrix and the error-signal matrix. In step 2456, the first-node-level weights are adjusted by adding the current W matrix and the weight-adjustments matrix ΔW. Then, in the for-loop of steps 2457-2461, the weights of the remaining node levels are similarly adjusted.

Thus, as shown in FIGS. 24A-F, neural-network training can be conducted as a series of simple matrix operations, including matrix multiplications, matrix transpose operations, matrix addition, and the Shur product. Interestingly, there are no matrix inversions or other complex matrix operations needed for neural-network training.

### Word and Sentence Embeddings

FIG. 25 illustrates word embeddings. Word embeddings are commonly used in natural-language processing (“NLP”). Given a vocabulary 2502 of m words, represented as an array of different words, a word-embeddings-generation process, represented by arrow 2504, produces a set of vectors 2506, each of which uniquely represents a word in the vocabulary. As shown by indexing of the vocabulary array 2502 and indexing of each vector in the set of vectors, there is a unique embedding vector corresponding to each word in the vocabulary. The embedding vectors have a fixed length n, with each element of each embedding vector a real number. Thus, words can be represented by embedding vectors. If the embedding vectors were simply another name or representation of the words of the vocabulary, they would have little utility. Instead, the embedding vectors are generated to have the property that the dot product of two embedding vectors representing two different vocabulary words generates a scalar value that reflects the semantic similarity of the words, as indicated by dot-product operation 2508 shown in the middle of FIG. 25. Thus, the dot-product operation is a compact, easily computed method for determining the similarity between any two words in the vocabulary.

FIG. 25 also shows one method by which the embedding vectors for a vocabulary are generated. This method uses a neural-network 2510 that includes an input layer 2512 of m nodes, a hidden layer 2514 of n nodes, and an output layer 2516 of m nodes, where m is generally greater than n, where m is the number of words in a vocabulary, and were n is the dimension of embedding vectors to be generated for the vocabulary. The neural-network receives, as input, a one-hot encoding of a vocabulary word x 2518. The one-hot encoding vector x is a vector of dimension m with all but one element, corresponding to the encoded word, having the value 0 and the element corresponding to the encoded word having the value 1. The neural network outputs a score, in each output node, for each word of the vocabulary. The m scores are then converted into a discrete probability distribution p 2520, each element of which represents the probability of the vocabulary word corresponding to the element having a relationship to the vocabulary word represented by the input one-hot-encoding vector 2518. The conversion of the m scores to the probability distribution p is obtained using the SoftMax function shown by expression 2522 in FIG. 25.

In one word-embeddings-generation process, the weights of the hidden-layer nodes for the inputs to the hidden-layer nodes corresponding to a one-encoded vocabulary word are used as the embedding vector. This can be seen when the weights of the hidden-layer nodes are represented by an m×n matrix W. The input values (see 2036 in FIG. 20) for the hidden node layer h is then W^{T}x. Since x has only a single non-zero element corresponding to an input vocabulary word, multiplication of x by the transpose of matrix W, W^{T}, selects a column of W^{T} corresponding to the row of matrix W that represents the weights of the hidden-layer nodes applied to the input from the input node corresponding to the input vocabulary word. In alternative word-embeddings-generation processes, weights associated with the output nodes may be used along with the weights of the hidden-layer nodes to generate the embedding vector for the input vocabulary word.

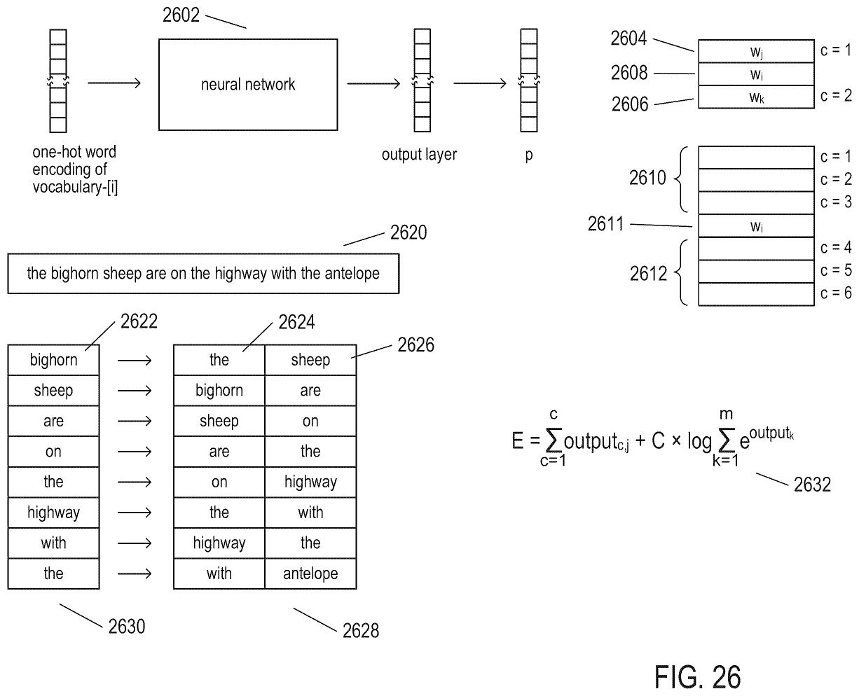

FIG. 26 illustrates one approach to training a neural-network used for generating embedding vectors for the words of a vocabulary. In the upper left-hand portion 2602 of FIG. 26, the inputs and outputs of the neural-network are again shown. In this approach, the neural network is trained to output a probability distribution p that indicates the probabilities of the words of the vocabulary preceding or following the input vocabulary word in textual training data. In one approach, the probabilities for words of the vocabulary immediately preceding 2604 or immediately following 2606 the input vocabulary word 2608 are contained in the output probability distribution p. In this case, there are C=2 positions with respect to the input word in text on which the probability distribution p is based. Another approach involves computing the probabilities for words of the vocabulary preceding the input word in text in a 3-word window 2610 preceding the input word 2611 or following the input word in a three-word window 2612 following the input word, in which case there are C=6 possible relative positions with respect to the input word. Other approaches, of course, are possible, with various different values of C and various different relative positions of vocabulary words with respect to the considered input word. As an example of the first approach, consider the text 2620. This text is produced by tokenizing the sentence: “The bighorn sheep or on the highway with the antelope.” The tokenizing process involves, in certain methods, removing punctuation and other non-word symbols, lowering upper-case letters, and other such operations that result in a uniform set of tokens corresponding to vocabulary words. Each internal word in the tokenized sentence 2620 therefore generates a different pair of words that precede and follow the internal word. For example, the word “bighorn” 2622 is preceded by the word “the” 2624 and followed by the word “sheep” 2626. The word pairs in the two-dimensional array 2628 represent pairs of words for which the output probabilities for the corresponding word in a rate 2630 should be relatively high. Thus, a large set of training data can be generated from a set of training documents in order to train the neural network to generate probabilities of words occurring in the proximity of an input word in the training documents. Expression 2632 is one expression for an error function used for training the neural-network, where output_{e,j} is the output for the pair of words, such as the words 2624 and 2626, for an input word, such as the word 2622, in the training data.

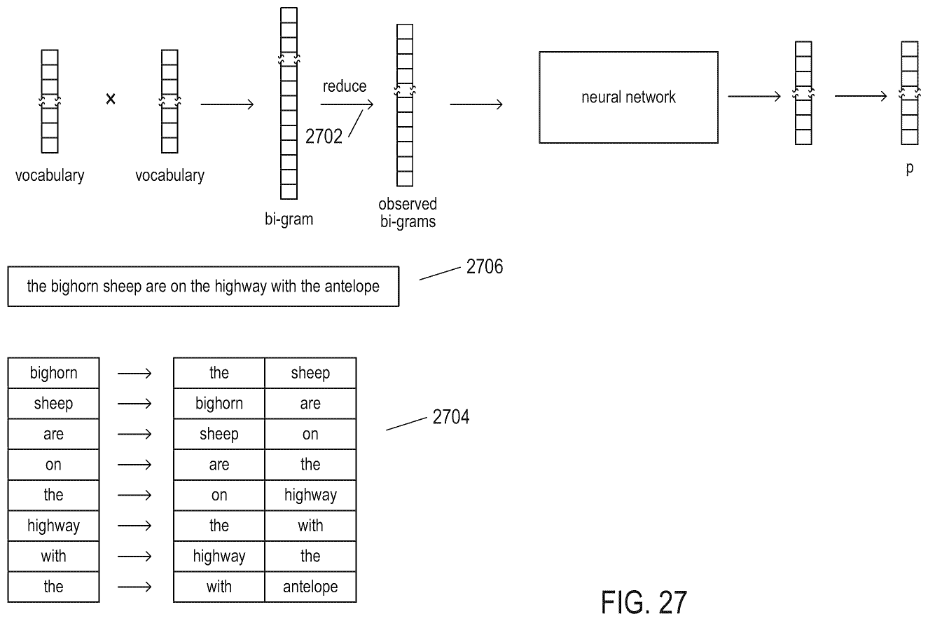

FIG. 27 shows that the same neural-network training approach discussed above with reference to FIG. 26 can be used to train a neural network to receive a one-hot encoding of a bi-gram, or pair of adjacent words in a training document, and output a probability distribution for the probabilities of vocabulary words occurring adjacent to the b-gram in the training documents. In this case, a single one-hot encoding of each bi-gram would naïvely be assumed to require input vectors of length m·n. However, the dimensionality of the one-hot encodings for bi-grams can be significantly reduced 2702 since only a generally small fraction of the possible bi-grams are actually observed in the training data. Some example training data 2704 are provided for bi-grams extracted from the same tokenized sentence 2706 used in the example shown in FIG. 26.

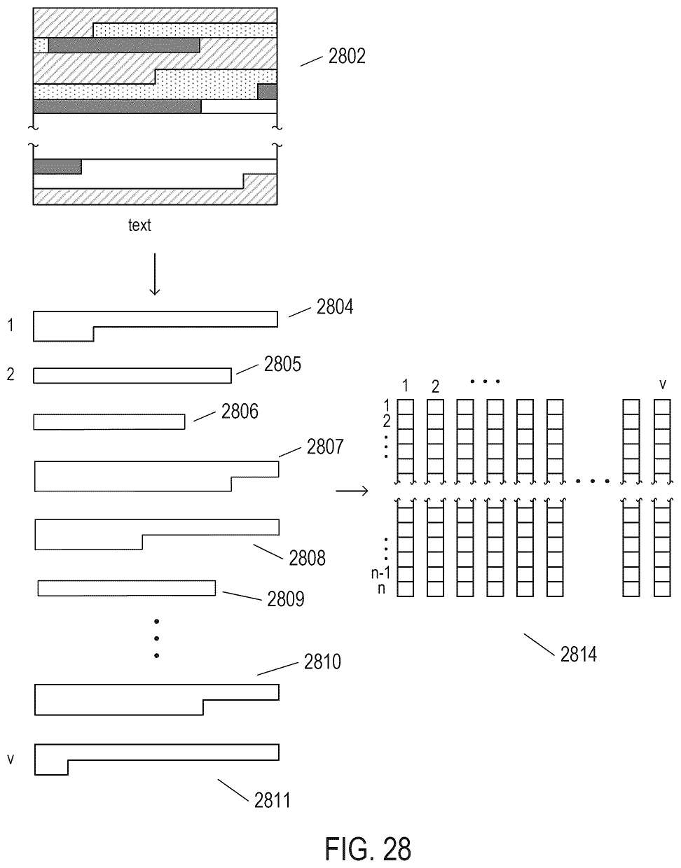

FIG. 28 illustrates sentence embeddings. A large set of textual data 2802 can be decomposed into sentences, such as sentences 2804-2811. Each sentence can be associated with a corresponding sentence embedding within a set of sentence-embedding vectors 2814. The sentence-embedding vectors have the same dot-product property as word-embedding vectors, where a dot product of the embedding vectors corresponding to two sentences generates a scalar value reflective of the similarity of the sentences.

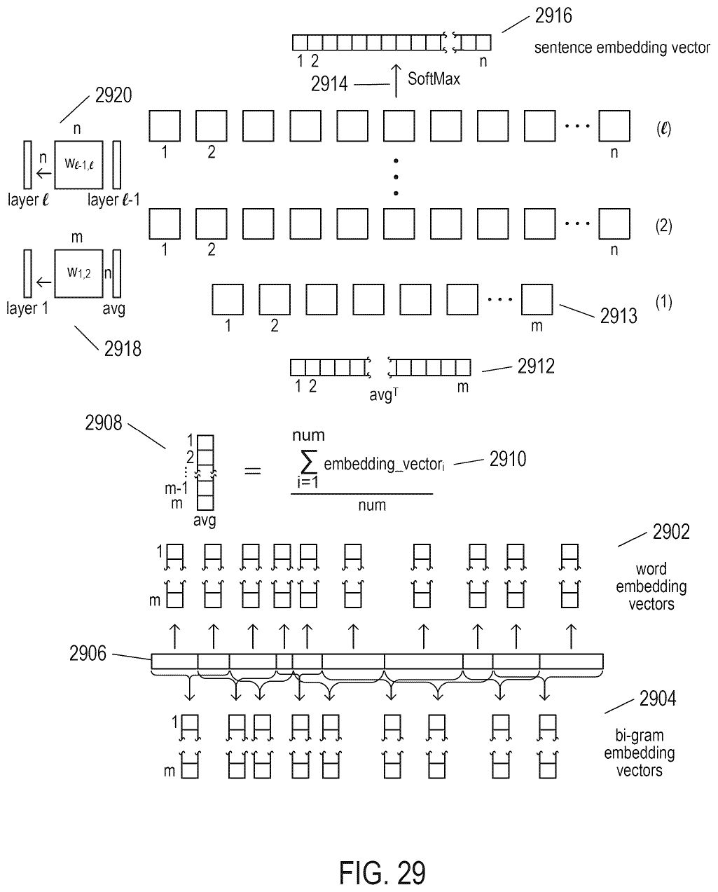

FIG. 29 illustrates one approach to generating sentence-embedding vectors. First, the word-embedding vectors 2902 and bi-gram embedding vectors 2904 corresponding to a tokenized sentence 2906 are collected and averaged to generate an average embedding vector 2908, as indicated by expression 2910. The transpose of the average embedding vector 2912 is input to a deep-averaging neural-network (“DAN”) 2913 and the SoftMax function 2914 is applied to the output of the DAN to produce a sentence embedding vector 2916 corresponding to the tokenized sentence 2906. The DAN includes l layers, the first of which includes m nodes, where m is the dimension of the word and bi-gram embedding vectors and the average embedding vector. The remaining layers of the DAN have n nodes, where n is the dimension of the sentence embedding vector. As with the neural-network used for generation of word-embedding vectors, the input values in nodes of a higher layer can be obtained by multiplication of a weight matrix and a vector of values output by the next lower layer, as indicated by matrix-multiplication diagrams 2918 and 2920.

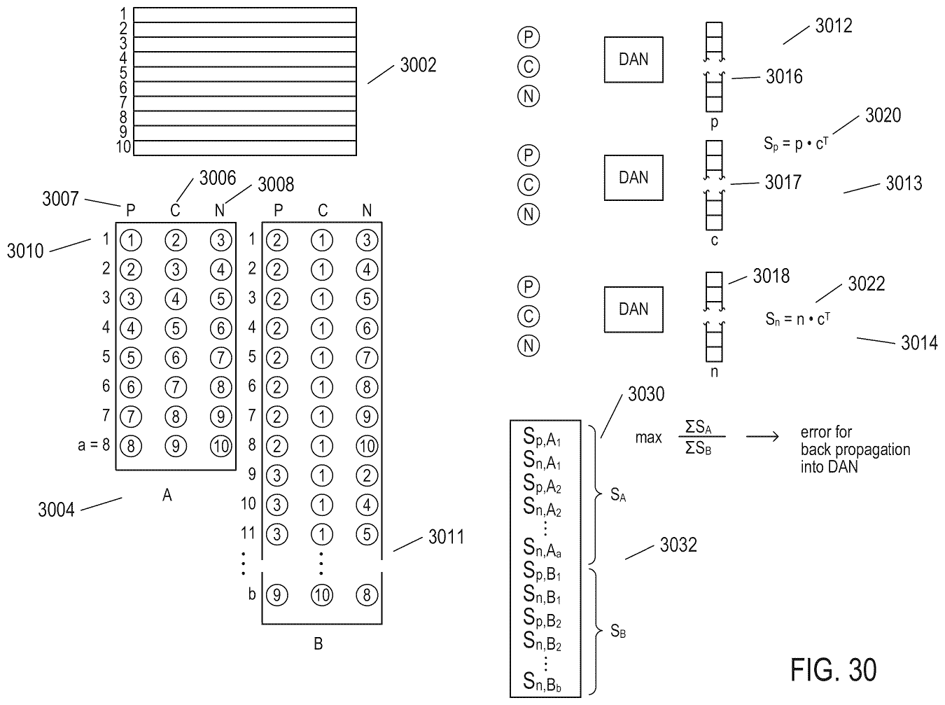

The DAN is generally trained using multiple different types of training data. FIG. 30 illustrates one example of training data used to train a DAN for use in generating sentence-embedding vectors. A set of tokenized sentences extracted from training documents 3002 is used in the illustrated approach. In the example shown in FIG. 30, only 10 tokenized sentences are shown, but, of course, in actual training, many more would be used. The first set of training data 3004 is generated by an approach similar to that illustrated in FIG. 26 for training the neural-network used to generate word-embedding vectors. Each row in the first set of training data represents a sequence of three adjacent sentences in the set of sentences 3002. The middle sentence of each sequence of three adjacent sentences is referred to as the “center” sentence, or C 3006. The initial sentence is referred to as the “previous” sentence, or P 3007, and the final sentence is referred to as the “next” sentence, or N 3008. Thus, the first row in the first training data set 3010 consists of the first, second, and third sentences in the set of sentences 3002. A second training data set 3011 is generated by all possible triples of the sentences in the training data that are not included in the triples in the first training data set 3004. In three successive steps 3012-3014, the three sentences of a sequence of three adjacent sentences retrieved from the training data set are input to the DAN to generate three sentence-embedding vectors 3016-3018 corresponding to the three sentences. Then, two similarity values are computed by the dot-product operation 3020 and 3022. The similarity values computed from the triples in the first training data set 3030 should have a relatively large values, if the sentence-embedding vectors from which they are computed are accurate, while the similarity values computed from the triples in the second training data set 3032 should have relatively low values. Thus, an error for back propagation into the DAN is generated in order to maximize the ratio of the sum of the similarity values generated from the first training set 3030 to the sum of the similarity values generated from the second training data set 3032.

### Currently Disclosed Methods and Subsystems

The currently disclosed methods and systems are directed to improving log/event-message subsystems by identifying log/event messages with semantically similar content that were generated or received within the same time window and aggregating the identified semantically similar log/event messages into a single aggregate log/event message. As discussed above, a given distributed computer system may include multiple different log/event-message subsystems with overlapping log/event-message sources. As a result, a given event may be detected by the multiple different log/event-message subsystems, with each of the multiple different log/event-message subsystems generating a corresponding log/event message. This may result in collection and storage of many redundant log/event messages. In addition, even a single log/event-message subsystem may generate multiple different log/event messages, with different but related contents, as a result of the occurrence of a single particular event. Thus, log/event-message redundancy may also arise in a single log/event message subsystem. When semantically similar, but redundant, log/event messages can be detected and aggregated, a significant decrease in the overall volume of collected and stored log/event messages can be obtained. This decrease in volume can directly translate into decreases in computational, networking, and data-storage overheads. More importantly, the presence of large numbers of redundant log/event messages create significant problems for automated log/event-message analysis systems, query interfaces to log/event-message databases, and human administrators, managers, and analysts who use log/event messages to detect, diagnose, and address many different types of problems, anomalies, and undesirable system states. Thus, a reliable log/event-message-system implementation that aggregates semantically related log/event messages can provide significant cost and performance benefits and can significantly simplify automated log/event-message analysis as well as semi-automated and manual log/event-message analysis.

FIG. 31 illustrates the concept of semantic content in log/event messages. As discussed above, a raw or unprocessed log/event message 3102 may include a variety of different types of fields, including: (1) source 3104 and destination 3105 network addresses; (2) a timestamp 3106; (3) various numeric and alphanumeric values not directly related to the type of log/event message 3108-3113; and (4) one or more phrases or sentences 3116 and 3117 that contain a description of, and information relevant to, the event represented by the log/event message. The first step in detecting semantically similar log/event messages within a log/event message stream is to extract the semantic content 3120 from the log/event message. The example shown in FIG. 31, the semantic content 3120 is the contents of the two crosshatched fields 3116-3117 in the unprocessed log/event message 3102. Extraction of the semantic content can be carried out using a variety of different techniques. In certain cases, the source of log/event messages implies a particular format or set of formats for log/event messages generated by the source. Information about these formats can, in many cases, precisely identify those fields within a log/event message likely to contain semantic content. In other cases, the log/event message can be parsed to identify natural-language phrases and text. Parsing can be at least partially implemented by sets of rules, regular expressions, and other such text-processing techniques.

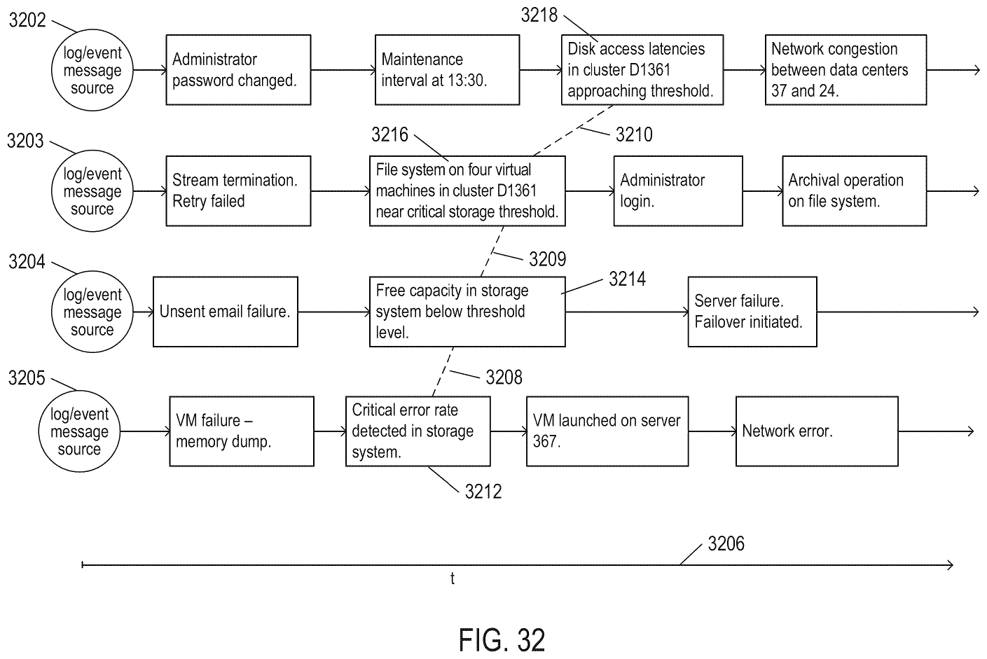

FIG. 32 illustrates an example of semantically similar content in redundant log/event messages. In FIG. 32, four different sources of log/event messages are represented by discs 3202-3205. A short time-ordered sequence of the semantic content extracted from log/event messages output by the log/event message source is shown for each log/event message source. The timeline 3206 at the bottom of FIG. 32 indicates that the log/event messages are ordered in time and indicate that the log/event-message content shown in FIG. 32 has been extracted from log/event messages that occur within the time interval represented by the time. The log/event messages sources may be the sources that first generated the log/event messages or may be higher-level components of one or more log/event-message subsystems. The four different examples of semantic content connected by dashed-line segments 3208-3210 contain different text, but all four are directly related to a common underlying event. Content 3212 indicates that a critical error rate has been detected in a storage system. Content 3214 indicates that the free capacity in a storage system is below a threshold level. Content 3216 indicates that the filesystems associated with four different virtual machines in a particular server cluster are near to a critical storage threshold, and content 3218 indicates that disk-access latencies in the server cluster are approaching a threshold level. While the text in the different semantically related content extracted from log/event messages differs, the four examples of semantic content describing observed events and phenomena are all related to saturation of the data-storage capacity in a server cluster. Although personnel familiar with the distributed computer system and log/event messages can quickly determine the relatedness of a small set of log/event messages, the determination nonetheless takes time and may be error prone. When terabytes of log/event messages are generated on a daily basis within a distributed computer system, it is clear that manual detection and aggregation of semantically similar, redundant log/error messages would be impossible. However, even automated detection and aggregation of semantically similar, redundant log/error messages may also be quite difficult, depending on the approach taken. Because of the high volume of log/event messages that need to be collected and processed within a distributed computer system, computationally complex natural-language processing technologies and other computational analysis technologies would almost all also be impossible to implement without severely impacting the availability of computational resources of a distributed computer system.

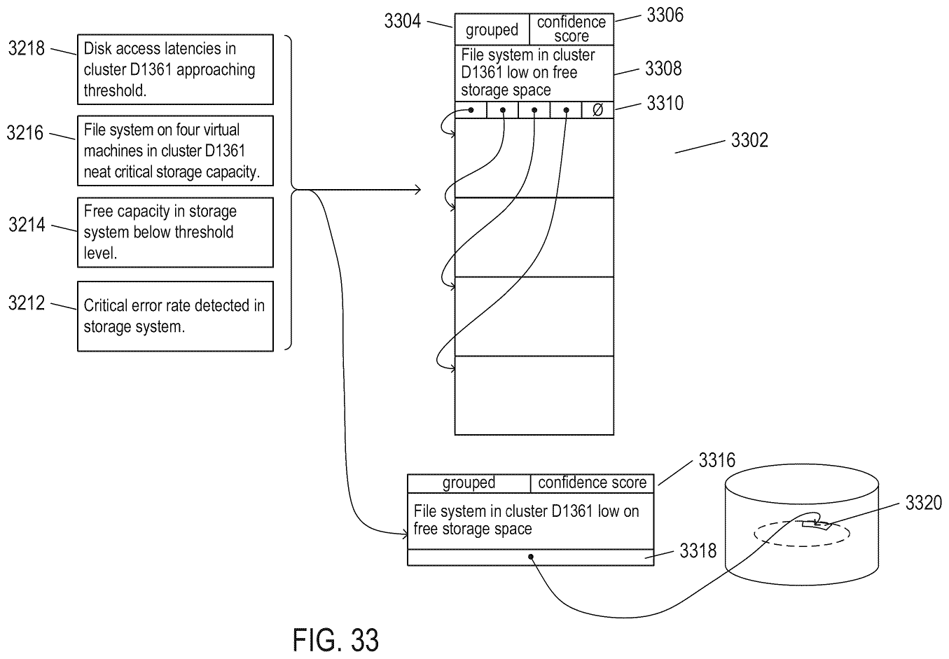

FIG. 33 illustrates several possible approaches to aggregating semantically similar log/event messages that occur in close proximity in time. The four similar semantic-content portions of log/event messages that occur within the time window shown in FIG. 32 are shown again in the left-hand portion of FIG. 33. One approach to aggregating the log/event messages containing this semantically-similar content is to include them in a single aggregate log/event message 3302. Such a message includes an indication that it is an aggregate log/event message 3304, a confidence score indicating the likelihood that the aggregation is justified by a measure of semantic similarity 3306, a summary of the content of the aggregated messages 3308, and then a list of pointers 3310 to compressed versions of the original log/event messages that are together aggregated by the aggregate log/event message. The confidence score may, for example, be computed as an average similarity metric associated with possible pairs of the semantically similar log/event messages. Other methods for computing a confidence score are possible. The compressed versions may include only a few relevant fields from the original log/event messages and may be additionally compressed by various different types of compression techniques that remove redundant information. Another approach is to generate a concise aggregate message 3316 that includes a reference 3318 to temporarily archived copies of the original log/event messages 3320, in case the original log/event messages are needed for subsequent analysis. Yet another approach is to simply generate a concise aggregate message that summarizes the original log/event messages that have been aggregated, particularly when the confidence score has a greater-than-threshold value.

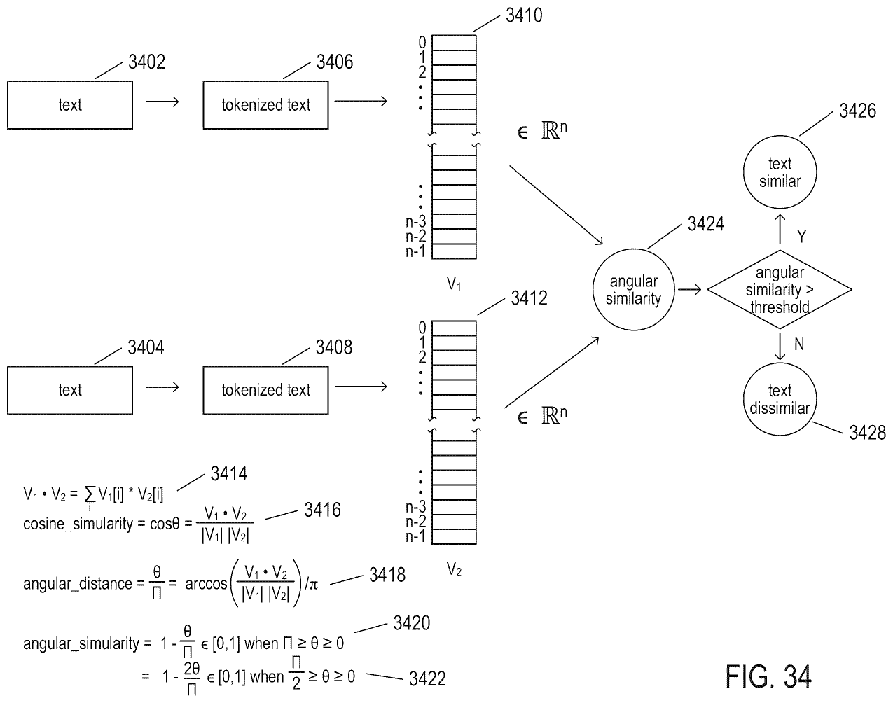

FIG. 34 illustrates determination of the semantic similarity of the semantic content of two log/event messages. Rectangles 3402 and 3404 represent the semantic content of two log/event messages. Semantic content is tokenized to produce tokenized text 3406 and 3408. The above-described method for generating sentence-embedding vectors is employed to generate embedding vectors 3410 and 3412 from the tokenized text. The dot product of these two vectors is computed according to expression 3414. The cosine similarity is obtained by dividing the dot product by the product of the magnitudes of the two vectors 3416. An angular distance between the two sentence-encoding vectors is computed according to expression 3418. In the case that the sentence-embedding vectors contain only positive real numbers and the real number 0, as a result of the particular approach used to compute them, an angular similarity is computed according to expression 3420. Otherwise an angular similarity is computed according to expression 3422. The computed angular similarity 3424 is then used to determine whether or not the semantic content of the two log/event messages are similar 3426 or dissimilar 3428 by comparing the computed angular similarity to a threshold value. In alternative implementations, other related similarity metrics can be computed from the two sentences-vectors and compared to corresponding threshold values. Thus, two log/event messages are semantically similar when a semantic-similarity metric computed from semantic content extracted from them, such as the angular distance or cosine similarity, has a value that, when compared to a threshold value, indicates that the two words are similar.

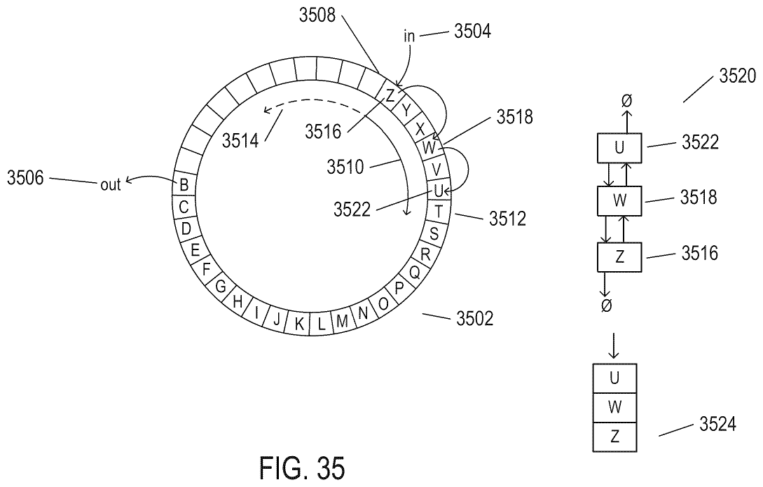

FIG. 35 illustrates one implementation of a sliding-window semantic-similarity-detection method incorporated in implementations of the currently disclosed methods and systems for aggregating semantically similar log/event messages. A circular queue 3502 is used as a buffer for log/event messages incoming to a message collector, message-ingestion-and-processor component, aggregator, or other component of a log/event-message system. As discussed above, a circular queue includes an in pointer and an out pointer 3506. A new entry represented by the symbol “Z” has just been added to the circular queue shown in FIG. 35, in the slot referenced by the in pointer, which has not yet been incremented. Following entry of the new queue entry into the circular queue, the in pointer will be advanced to reference slot 3508, as discussed above. In the illustrated implementation, the semantic contents of the new entry are compared to the semantic contents of the other entries already within an already-queued portion 3510 of a sliding time window. The final element 3512 in this already-queued portion of the sliding time window can be detected by comparing a timestamp included in the entry to the timestamp of the just-entered entry, in certain implementations. In other implementations, when it is known that log/event messages are generally queued at a relatively constant rate, the determination can be made simply based on a fixed number of queue entries, since a number of successive queue entries is proportional to a period of time that can be approximate by the product of the inverse of the number of entries queues per unit of time and the number of successive queue entries. In yet other implementations, the already-queued portion of the sliding time window is assumed to extend all the way to the entry referenced by the out pointer, since it is known that queue entries are removed quickly from the circular queue at a rate similar to the rate at which entries are queued to the circular queue. The other portion of the sliding time window 3514, indicated by the dashed curved line FIG. 35, extends forward in time to include subsequent entries added to the circular queue. The number of queue entries in this portion of the sliding time window is determined by a method symmetrical to the method for determining the number of entries in the already-queued portion of the sliding time window. These various different methods are possible since a circular queue is inherently a sliding-time window when it buffers log/event messages on behalf of two asynchronous processes, one of which adds log/event messages to the circular queue and the other of which removes log/event messages from the circular queue. The log/event messages currently resident within a circular queue or other first-in-first-out buffer are therefore temporally proximate.

Comparisons of the semantic contents of the currently added queue entry to the already-queued entries in the already-queued portion of the sliding time window are used to determine the most closely semantically related already-queued entry to the currently added queue entry. When the most closely semantically related already-queued entry has a semantic similarity to the just-added entry greater than a threshold similarity value, the currently added queue entry is linked to that queue entry for subsequent aggregation. In the example shown in FIG. 35, the currently added queue entry 3516 referenced by the in pointer is determined to have greatest semantic similarity to queue entry 3518 and is therefore added to a doubly-link list 3520 in which queue entry 3518 was the last-queued entry on the doubly link list. Queue entry 3518 has already been added to a doubly link list that includes queue entry 3522 as the first entry in the doubly-link list. When queue entry 3522 is eventually removed from the circular queue by a get operation, the doubly-link list that extends from queue entry 3522 back to queue entry 3516 will be detected and all of the queue entries on the doubly-link list will be aggregated into an aggregate log/event message 3524.

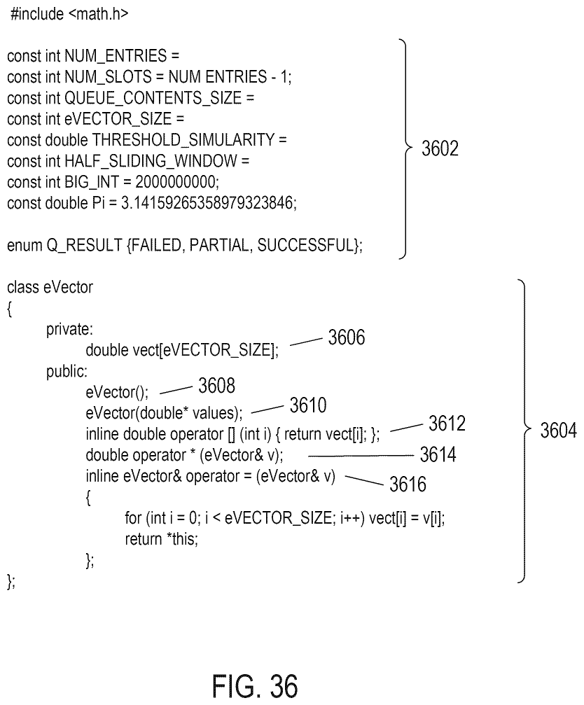

FIGS. 36-43 provide a simple C++ implementation of the sliding-window similarity-based aggregating circular queue discussed with reference to FIG. 35. FIG. 36 shows initial constant and enumeration declarations 3602 as well as the declaration of an embedding-vector class eVector 3604. The constant declarations include declarations of: (1) the integer constant NUM_ENTRIES, which is the total number of queue entries in the circular queue; (2) the integer constant NUM_SLOTS, which is the total number of slots into which queue entries can be input within the circular queue; (3) the integer constant QUEUE_CONTENTS_SIZE, the size of a slot in the circular queue; (4) the integer constant eVECTOR_SIZE, the dimension of the embedding vectors; (5) the floating-point constant THRESHOLD_SIMULARITY, the threshold for determining whether or not the semantic content of two log/event messages are similar; (6) the integer constant HALF_SLIDING_WINDOW, the maximum number of queue entries in the already-queued portion of the sliding time window; (7) the integer constant BIG_INT, a large integer; and (8) the floating-point constant Pi, an approximate value for the constant n. The enumeration Q_RESULT is returned by get and put operations on the circular queue, and indicate whether the operations are successful, have failed, or are partially successful in the sense that at least a portion of the contents of queue entries retrieved by a get operation has been successfully transferred to a buffer or at least a portion of the content of a log/event message argument of a put operation has been successfully transferred to a queue entry.

Instances of the embedding-vector class eVector 3604 are embedding vectors that represent semantic portions of log/event messages. An embedding vector is stored in the floating-point array vect 3606. Member functions include a first constructor 3608 and a second constructor 3610 that receives a pointer to floating-point values with which to initialize the floating-point array vect. Other member functions include implementations of the operator “[ ]” for selecting elements of the embedding vector 3612, an implementation of a dot-product operator 3614, and an assignment operator 3616.

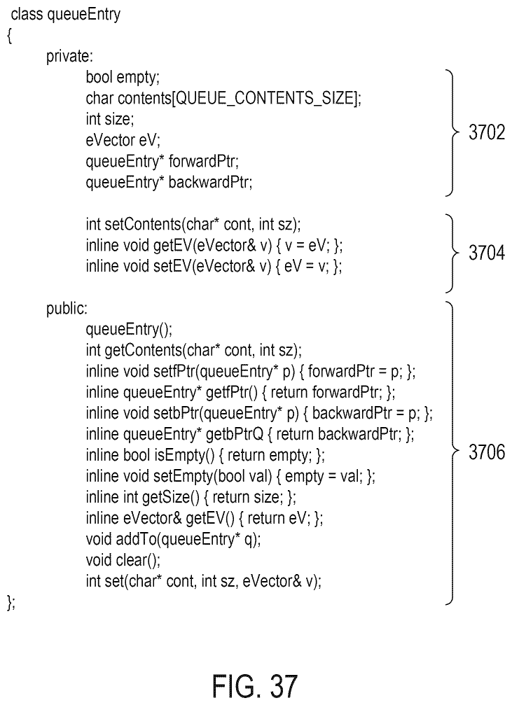

FIG. 37 shows a declaration for the class queueEntry, instances of which are entries and slots in the circular queue. The class declaration includes a set of private data members 3702, a set of private member functions 3704, and a set of public member functions 3706. The private data members include: (1) empty, a Boolean variable that indicates whether or not the queue entry contains valid contents; (2) contents, a buffer for the contents of the queue entry; (3) size, the number of bytes in the buffer contents occupied by valid queue-entry content; (4) eV, the embedding vector for the content; (5) forwardPtr, the forward pointer for the doubly linked list of similar queue entries that include the queue-entry instance; and (6) backwardPtr, a backward pointer for the doubly linked list of similar queue entries that include the queue-entry instance. The private function members for the class queue Entry include: (1) setContents( ), which transfers contents from a buffer referenced by the first argument to the contents private data member; and (2) getEV( ) and setEV( ), which retrieve and assign a value to the embedding vector, respectively. The public member functions include: (1) a constructor; (2) getContents( ), which extracts the contents from a queue entry; (3) setfPtr( ) and getfPtr( ), which set and retrieve the value of the forward pointer; (4) setbPtr( ) and getbPtr( ), which set and retrieve the value of the backward pointer; (5) isEmpty( ) and setEmpty( ), which retrieve and set the Boolean data member empty; (6) getSize( ), which returns the size, in bytes, of the contents of the queue entry; (7) getEV( ), which returns the embedding vector eV; (8) addTo( ), which adds a queue entry to the doubly linked list containing the instant queue entry; (9) clear( ), which reinitializes the queue entry; and (10) set( ), which initializes the queue entry to contain the contents and embedding vector supplied as arguments.

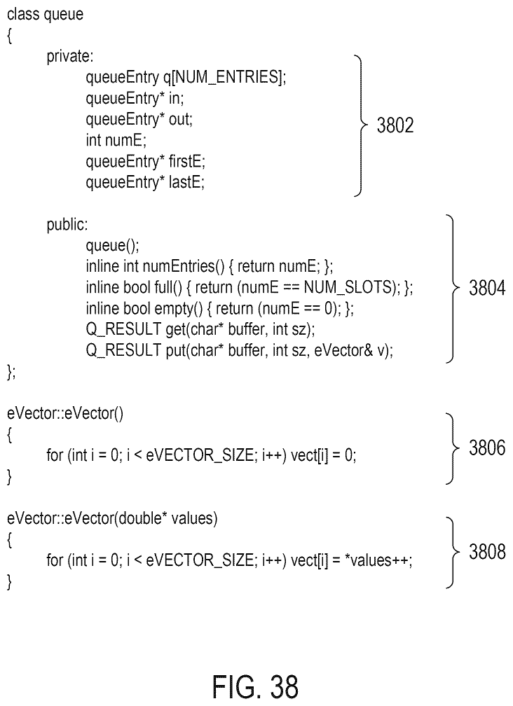

FIG. 38 shows a declaration for the class queue, instances of which are circular queues. The class declaration includes a set of private data members 3802 and a set of public member functions 3804. The private data members include: (1) q, a linear memory buffer of queue entries; (2) in and out, the traditional in and out pointers of a circular queue; (3) numE, the number of entries currently resident in the circular queue; and (4) firstE and lastE, pointers to the first and last entries in the linear buffer of queue entries. The public member functions include: (1) a constructor; (2) numEntries( ), which returns the number of entries currently resident in the circular queue; (3) full( ) and empty( ), which returns the Boolean values indicating whether or not the circular queue is full and whether or not the circular queue is empty, respectively; (4) get( ), which implements the get function for the circular queue, discussed above; and (5) put( ), which implements the put function for the circular queue, also discussed above.

FIG. 38 also shows implementations of the constructors for the class eVector. The first constructor 3806 takes no arguments and sets all the elements of the member vector vect to zero. The second constructor 3808 receives a reference to an array of real numbers and uses the real numbers to initialize the member vector vect.

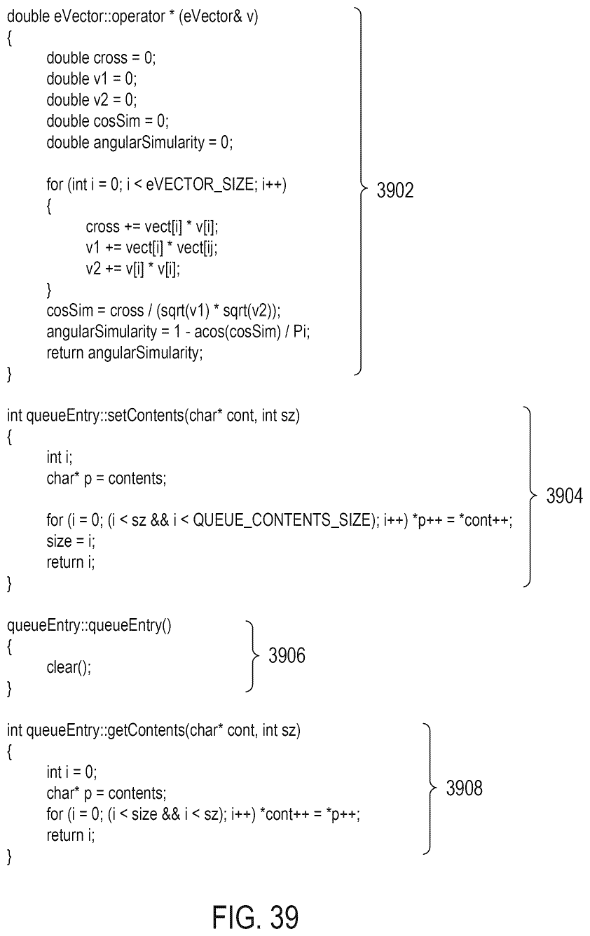

FIG. 39 shows implementations of the dot-product operator 3902 for the class eVector, the setContents member function 3904 for the class queueEntry, the constructor for the class queueEntry 3906, and the member function getContents 3908 for the class queueEntry. The dot-product operator 3902 implements the computation of the angular similarity 3422, discussed above with reference to FIG. 34. The remaining member-function implementations shown in FIG. 39 are straightforward.

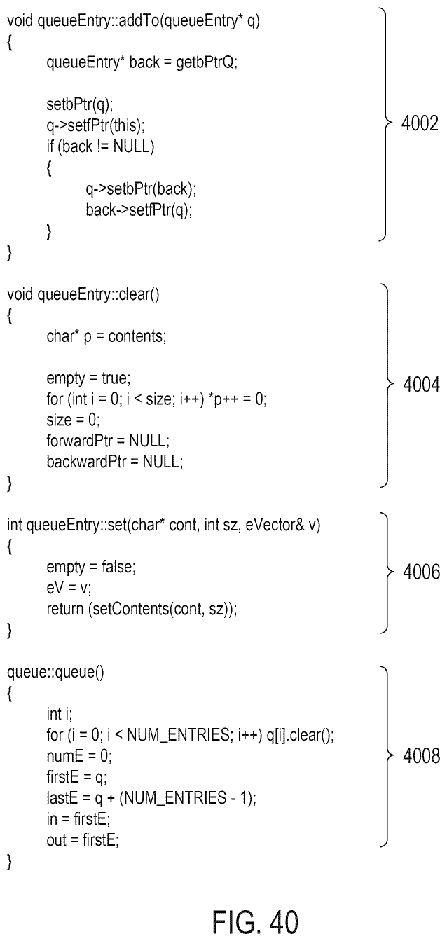

FIG. 40 shows implementations of the member function addTo( ) for the class queue Entry, the member function clear( ) or the class queueEntry, the member function set( ) for the class queueEntry, and the constructor for the class queue 4008. The member function addTo( ) receives a pointer to a queue entry, as an argument, and adds that queue entry to the doubly linked list that includes the queueEntry instance calling the function. The member function clear( ) or the class queueEntry re-initializes the queue entry. The member function set( ) for the class queue Entry initializes a queue entry to contain the contents described by the arguments cont and sz and the embedding vector referenced by argument v. The constructor for the class queue initializes the circular queue to the empty state discussed above with reference to FIG. 18.

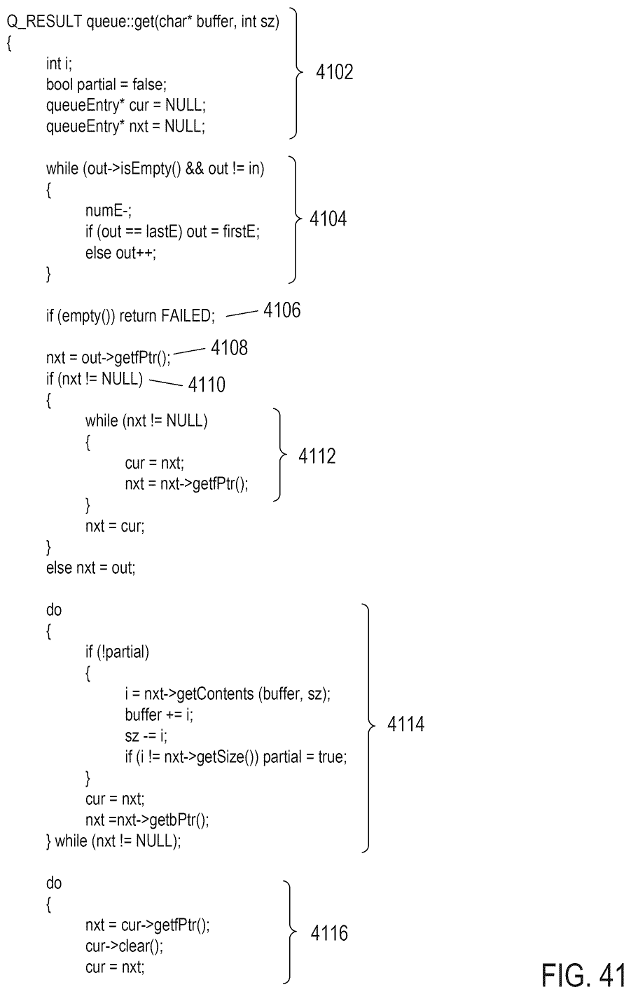

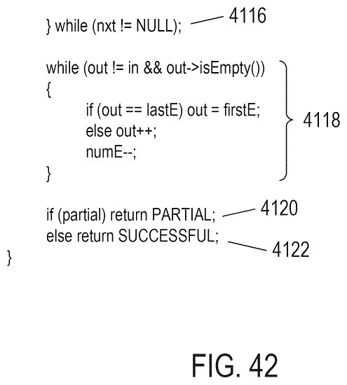

FIGS. 41-42 show an implementation for the function get( ) for the class queue. This is one of the primary circular-queue functions or operations that retrieves the next available entry from the circular queue, as discussed above with reference to FIG. 18. First, a number of local variables are initialized 4102. In the while-loop 4104, the out pointer is decremented, along with the data member numE, until the out pointer points to a non-empty circular-queue slot. This removes queue entries corresponding to log/event messages that were aggregated together by a previous call to the member function get( ) When the circular queue is empty, a return value of FAILED is returned by the if statement 4106. Then, local variable nxt is set to the forward pointer of the queue entry referenced by the out pointer 4108. When the forward pointer is not null, as detected in if statement 4110, the while-loop 4112 is executed to advance the pointer nxt to point to the first queue entry in the doubly linked list. In the do-while loop 4114, the doubly linked list is traversed to aggregate all of the queue entries on the doubly linked list into an aggregate log/event message, with the aggregate contents of all the queue entries in the doubly linked list copied to the buffer referenced by the first argument of the member function get( ). Then, in the do-while loop 4116, the doubly link list is traversed in reverse to set all of the queue entries that were aggregated to the empty state. Finally, in the while-loop 4118, the out pointer and data member numE are decremented until the out pointer points to a non-empty queue entry or until the circular queue is empty. A return value of PARTIAL is returned when there was insufficient space in the buffer referenced by the argument buffer to store the contents of the log/event message or log/event messages retrieved from the circular queue 4120. Otherwise, a return value of SUCCESSFUL is returned 4122.

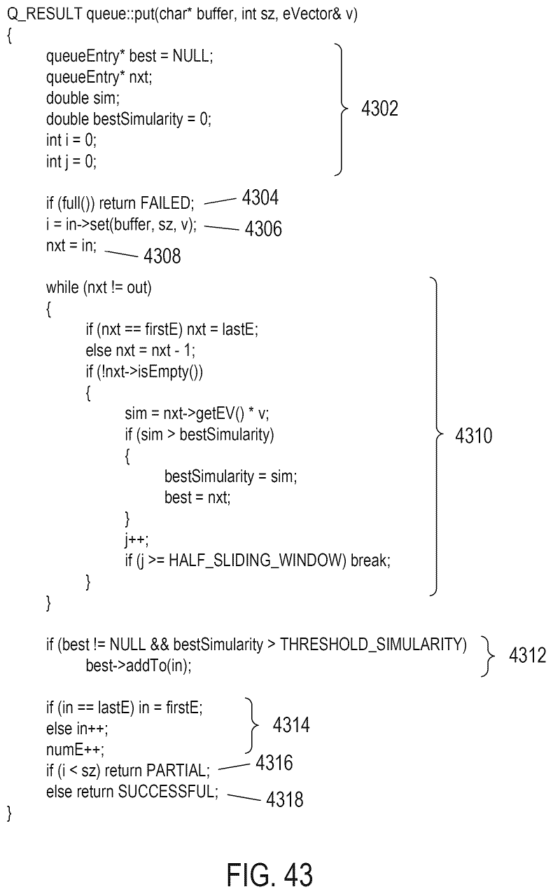

FIG. 43 shows an implementation for the function put( ) for the class queue. This is one of the primary circular-queue functions or operations that adds an entry to the next available free slot of the circular queue, as discussed above with reference to FIG. 18. First, a number of local variables are initialized 4302. When the queue is full, a return value of FAILED is returned 4304. The next available free slot in the circular queue is filled with the queue entry characterized by the arguments to the member function put 4306. Then, the local variable nxt is set to reference the just-filled queue entry 4308 in the while-loop 4310, local variable nxt is iteratively advanced until all of the previously entered queue entries have been considered or until a number of queue entries equal to the constant HALF_SLIDING_WINDOW have been considered. A similarity value is computed for each considered queue entry and the just-added queue entry and, when the computed similarity value is greater than any similarity value computed for previously considered queue entries, the considered queue entry and the similarity value are stored for subsequent comparisons. At the completion of while-loop 4310, local variable best is either null, indicating that no queue entry with a similarity equal or greater than a threshold value to the just-added queue entry was found, or references the most similar queue entry within the queue entries in the already-queued portion of the sliding window. When local variable best is not null and the similarity value for the queue entry referenced by local variable best and the just-added queue entry is greater than the constant THRESHOLD_SIMULARITY, the just-added entry is queued to the doubly-linked list that also includes the queue entry referenced by local variable best 4312. The pointer in is then incremented 4314. When the full contents of the log/event message just added to the circular queue were not able to be copied into the just-added queue entry, a return value of all PARTIAL is returned 4316. Otherwise, the return value SUCCESSFUL is returned 4318.

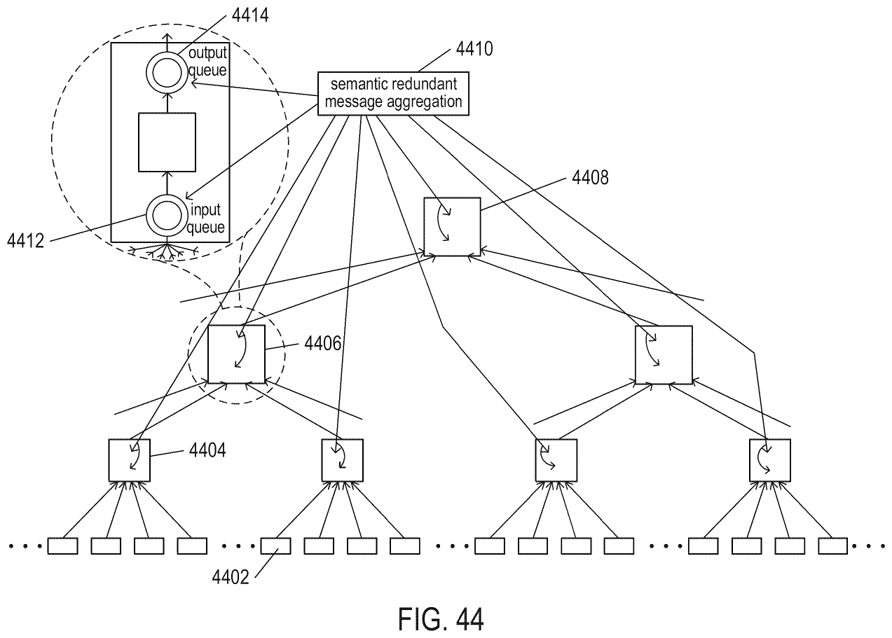

FIG. 44 illustrates various points in a log/event-message system at which similar-message-aggregating queues can be used for aggregating semantically similar log/event messages. FIG. 44 illustrates two concurrently operating log/event-message subsystems that collect, process, and store log/event messages and that provide log/event messages to a higher-level aggregator, as discussed above with reference to FIGS. 13C-D. The lowest level rectangles, such as rectangle 4402, represent log/event-message sources. The next level of rectangles, such as rectangle 4404, represent message collectors. The next level of rectangles, such as rectangle 4406, represent log/event-message ingestion-and-processing components. A highest-level rectangle 4408 represents an aggregator that aggregates log/event messages collected, processed, stored, and forwarded to the aggregator by multiple log/event-message subsystems. As indicated by arrows emanating from rectangle 4410, similar-message-aggregating queues, such as the circular queue discussed above with reference to FIGS. 35-43, can be used for one or both of the input queue 4412 and the output queue 4414 in any of the message collectors, message-ingestion-and-processing components, and aggregator component. In many cases, it may be advantageous to carry out log/event-message aggregation at the message-collector level in order to forestall transmission of redundant log/event messages to, and processing of redundant log/event messages by, higher-level components. In general, log/event-message aggregation needs to be included in aggregator components to remove redundancies resulting from similar messages generated for common events by multiple log/event-message subsystems as well as to simplify analysis by automated, semi-automated, and human analysts. Within a given component, semantically similar-message aggregation carried out at the input queue can prevent unnecessary processing overheads for redundant messages received by the component. In general, each different distributed computer system may have particular characteristics and operational behaviors that dictate in which components to include semantically similar-message aggregation in order to obtain an optimal cost/benefit ratio. Clearly, log/event-message aggregation is associated with computational overheads, but these computational overheads can often be outweighed by avoiding much larger computational, networking, and storage overheads involved with processing and storing unnecessarily high volumes of log/event messages. Furthermore, removing redundant, similar log/event messages can greatly increase the efficiency for analyzing log/event messages to detect, diagnose, and ameliorate anomalous operational behaviors within distributed computer systems.

Training of the neural networks used for generating word, bi-gram, and sentence-embedding vectors can be carried out in many different ways, at different times, and by different components of a distributed computer system. For example, sets of word-embedding vectors and bi-gram embedding vectors can be obtained from processing of general textual data in the language used for the semantic content of log/event messages. Training data can be harvested from archives of log/event messages for generation of sentence-embedding vectors. The training can be carried out independently of the operation of the log/event-message system within particular distributed computer systems or, in alternative implementations, can be intermittently carried out by a log/event-message subsystem on recently received and processed log/event messages. In general, because training of the neural networks is largely unsupervised and can be carried out externally to operating log/event-message subsystems, the training overheads do not generally significantly contribute to the overhead of log/event-message collection, processing, and storage.

The present invention has been described in terms of particular embodiments, it is not intended that the invention be limited to these embodiments. Modifications within the spirit of the invention will be apparent to those skilled in the art. For example, any of many different implementations of the log/event-message system can be obtained by varying various design and implementation parameters, including modular organization, control structures, data structures, hardware, operating system, and virtualization layers, and other such design and implementation parameters. As discussed above, semantically similar-message aggregation can be carried out and many different points in a log/event-message system. Various different methods and technologies for determining semantic similarity of log/event messages can be employed.

What is claimed is:

1. An improved log/event-message system, within a distributed computer system, that collects log/event messages from log/event-message sources within the distributed computer system, stores the collected log/event messages, and provides query-based access to the stored log/event-messages, the log/event-message system comprising:
one or more log/event-message subsystems, that each
collects, processes, and stores log/event messages, and
provides query-based access to the stored log/event messages; and
one or more semantic-similarity-based log/event-message aggregators, incorporated into one or more of the one or more log/event-message subsystems, that each
receives log/event messages,
identifies groups of one or more of the received log/event messages that are mutually semantically similar and that are temporally proximate, and
aggregates the identified groups of log/event messages to generate an aggregate log message that is output to downstream components of the one or more log/event-message subsystems.

2. The improved log/event-message system of claim 1 wherein log/event-messages include text, alphanumeric values, and/or numeric values that represent various types of information, including notification of completed actions, errors, anomalous operating behaviors and conditions, various types of computational events, warnings, and other such information.

3. The improved log/event-message system of claim 2 wherein the information in a log/event message can be portioned into semantic content, including words, phrases, and other natural-language constructs, and non-semantic content.

4. The improved log/event-message system of claim 3 wherein the semantic similarity of the semantic content of two log/event messages is determined by:
mapping the semantic content of a first log/event message of the two log/event messages to a first embedding;
mapping the semantic content of a second log/event message of the two log/event messages to a second embedding; and
carrying out an operation on the first and second embeddings to produce a similarity-metric value.

5. The improved log/event-message system of claim 4 wherein the first log/event message is semantically similar to the second log/event message
when increasing similarity-metric values indicate greater similarity and when the produced similarity-metric value is greater than a threshold value; or
when decreasing similarity-metric values indicate greater similarity and when the produced similarity-metric value is less than a threshold value.

6. The improved log/event-message system of claim 4
wherein embeddings of the semantic contents of log/event messages are fixed-size vectors of floating-point values; and
wherein the operation carried out to generate the similarity metric includes
generating the scalar dot product of the first and second embeddings,
computing the cosine of an angle between the two vectors by dividing the dot product by the product of the magnitudes of the first and second embedding, and
computing an angular similarity from the angle between the two vectors.

7. The improved log/event-message system of claim 4 wherein the semantic content of a log/event message is mapped to an embedding by:
tokenizing the semantic content to produce a set of words;
generating word embeddings and bi-gram embeddings from the tokenized semantic content;
generating an average embedding by averaging the generated word embeddings and bi-gram embeddings; and
imputing the average embedding to a trained deep-averaging network, which outputs a corresponding embedding for the tokenized semantic content.

8. The improved log/event-message system of claim 1 wherein the groups of one or more of the received log/event messages that are mutually semantically similar and that are temporally proximate are identified by:
storing the received log/event messages in a time-ordered sequence;
superimposing a sliding time window over the time-ordered sequence of stored log/event messages to determine groups of temporally proximate log/event messages; and
selecting semantically similar groups of log/event messages from the sliding time window.

9. The improved log/event-message system of claim 8 wherein the received log/event messages are continuously added to a first-in-first-out queue as they are received and subsequently removed from the first-in-first-out queue for one or more of:
processing;
storage in a database;
analysis; and
transmission to downstream components of the log/event message system.

10. The improved log/event-message system of claim 8 wherein selecting semantically similar groups of log/event messages from the sliding time window further comprises:
for each newly received log/event message,
identifying a most similar already-received log/event message to the newly received log/event message in an already-received portion of the sliding time window, and
when a most similar already-received log/event message is identified, adding the newly received log/event message to a group of semantically similar log/event messages that includes the most similar already-received log/event message.

11. The improved log/event-message system of claim 1 wherein an aggregate log/event message contains a representative semantic content derived from the semantic contents of a group of semantically similar log/event messages.

12. The improved log/event-message system of claim 11 wherein the aggregate log/event message additionally contains a confidence value indicating a likelihood that the group of semantically similar log/event messages represent a common event.

13. The improved log/event-message system of claim 11 wherein the aggregate log/event message additionally contains a compressed form of all or portions of the log/event messages in the group of semantically similar log/event messages.

14. The improved log/event-message system of claim 11 wherein the aggregate log/event message additionally contains references to stored copies of the log/event messages in the group of semantically similar log/event messages.

15. A method that determines whether or not two log/event messages are semantically similar, the method comprising:
receiving a first log/event message and a second log/event message;
extracting first semantic content from the first log/event message;
tokenizing the first semantic content to produce a first set of tokens;
receiving a second log/event message;
extracting second semantic content from the second log/event message;
tokenizing the second semantic content to produce a second set of tokens;
mapping the first set of tokens to a first embedding;
mapping the second set of tokens to a second embedding;
generating a similarity-metric value from the first embedding and the second embedding; and
comparing the similarity-metric value to a threshold value to determine whether or not two log/event messages are semantically similar.

16. The method of claim 15 wherein the embeddings are vectors of floating-point numbers with a particular dimension.

17. The method of claim 16 wherein a set of tokens is mapped to a vector of floating-point numbers by:
generating embeddings for words and bi-grams extracted from the set of tokens;
generating an average embedding from the embeddings extracted from the set of tokens; and
inputting the average embedding to a deep-averaging network, which outputs an embedding corresponding to the set of tokens.

18. The method of claim 16 wherein the similarity-metric value is generated from a dot product of the first embedding and the second embedding.

19. The method of claim 16 wherein the similarity-metric value is generated from a dot product of the first embedding and the second embedding by:
dividing the dot product by the product of the magnitudes of the first embedding and the second embedding to generate the cosine of an angle; and
returning, as the similarity-metric value, one of
the cosine of the angle,
the angle,
an angular distance obtained by dividing the angle by n, and
an angular similarity obtained by subtracting an angular-distance term from 1.

20. A physical data-storage device that stores computer instructions that, when executed by processors within computer systems of a log/event-message system within a distributed computer system, control the log/event-message system to:
receive log/event messages, for each received log/event message
extracting a semantic content from the received log/event message;
tokenizing the extracted semantic content to produce a set of tokens;
mapping the set of tokens to an embedding; and
adding the log/event message to a first-in-first-out queue in association with the embedding; and
retrieve a semantically similar group of log/event messages from the first-in-first-out queue by using the embeddings associated with the log/event messages in the queue to identify semantically similar log/event messages in the first-in-first-out queue for retrieval.
